(19) United States
(12) Patent Application Publication
(10) Pub. No.: US 2015/0278483 A1
(43) Pub. Date: Oct. 1, 2015

(54) System and Technique To Document A Patient Encounter

(71) Applicant: Mark A. Pruitt, Hood River, OR (US)

(72) Inventor: Mark A. Pruitt, Hood River, OR (US)

(21) Appl. No.: 14/640,128

(22) Filed: Mar. 6, 2015

Related U.S. Application Data
(60) Provisional application No. 61/949,321, filed on Mar. 7, 2014.
(60) Provisional application No. 62/074,306, filed on Nov. 3, 2014.

(51) Int. Cl. G06F 19/00

(52) U.S. Cl. CPC G06F 19/3487

(57) ABSTRACT

A technique includes displaying an anatomical model of a human on a display of a processor-based machine; and in the processor-based machine, input data acquired from a user interacting with the displayed anatomical model is processed to provide or update an electronic health record in response to an encounter between the clinician and a patient. The processing includes selecting an interface from a plurality of interfaces based on user interaction with the displayed anatomical model as a result of the encounter, displaying the selected interface and gathering input data in response to the user interaction with the selected interface. The technique includes determining content to be included in the electronic health record based at least in part on the input data.

### BACKGROUND

A clinician typically documents an encounter with a patient so that the documented encounter becomes part of the patient's medical record. One method of documenting a patient encounter involves the creation of a SOAP note, which is an acronym for a subjective, objective, assessment and plan. In this regard, the subjective component of the SOAP note documents the patient's chief complaint, i.e., the brief statement of the patient as the purpose of the visit to the clinician; the objective component pertains to the clinician's observations of the patient; the assessment of the SOAP note is the clinician's assessment of the main symptoms and/or diagnosis for the patient; and the plan refers to the treatment plan that is provided by the clinician.

### BRIEF DESCRIPTION OF THE DRAWINGS

FIG. 1 is a schematic diagram of a computer system to document a patient encounter and update an electronic health record (EHR) of the patent according to an example implementation.

FIGS. 2A and 2B depict flow diagrams depicting techniques to document patient encounters according to example implementations.

FIGS. 3A, 3B and 3C depict example images of a graphical user interface (GUI) to document a patient encounter according to example implementations.

FIGS. 4A and 4C depicts anterior skin map images displayed by the GUI according to example implementations.

FIGS. 4B and 4D depict posterior skin map images displayed by the GUI according to example implementations.

FIGS. 5A and 5B illustrate a color coding scheme used by a skin map image according to an example implementation.

FIG. 6 depicts schema associated with a skin map image according to an example implementation.

FIG. 7A depicts a PIN image displayed by the GUI and associated with a left front rib according to an example implementation.

FIGS. 7B, 7C, 7D, 7E, and 7F depict PIN images displayed by the GUI and associated with tonsils according to an example implementation.

FIGS. 8A, 8B and 8C illustrate PIN schema according to an example implementation.

FIGS. 9A, 9B and 9C are screenshots of a body image page of a virtual desk of the GUI according to an example implementation.

FIG. 10 is an illustration of a vitals page image of the virtual desk according to an example implementation.

FIGS. 11A, 11B, 11C and 11D depict example images of the virtual desk illustrating manipulation of patient records on the desk according to example implementations.

FIG. 12 is a schematic diagram of a physical machine according to an example implementation.

FIG. 13 is a flow diagram depicting a technique to document a patient encounter according to an example implementation.

FIGS. 14, 15, 16 and 17 are illustrations of the use of a split screen GUI to document a patient encounter and update an EHR of the patent according to a further example implementation

### DETAILED DESCRIPTION

Systems and techniques are disclosed herein for purposes of enhancing and facilitating the documentation of an encounter between a patient and a healthcare provider (physicians, physician assistants (PAs), family nurse practitioners (FNPs), and so forth). In the context of this patent application, the healthcare provider may be considered a clinician in that the provider has direct contact with and treats the patient. Moreover, in the context of this application, a clinician may, in general, refer to any healthcare worker who interacts and treats a patient, such as a physician, physician assistant (PA), family nurse practitioner (FNP), surgeon, and so forth

More specifically, in accordance with example implementations, the clinician uses a tool (called “the conduit tool 110” herein) that presents a graphical user interface (GUI) 111 that is constructed to efficiently document a patient encounter as well as efficiently provide access to the patient's medical history as part of the documentation process. As described herein, the conduit tool 110 accesses a three-dimensional (3-D) anatomical human model 112 to 1.) display images corresponding 3-D anatomical human models and aspects of the models related to documenting a patient encounter; 2.) gather input from the clinician in response to the clinician's interaction with the displayed images; and 3.) update/generate an electronic health record (EHR) for the patient in response to this interaction. In this manner, the clinician may use the conduit tool 110 for such purposes as efficiently gathering subjective, objective, assessment, and plan (SOAP) notes; selecting the affected human body system(s) relevant to a given patient encounter; marking regions of the human body associated with patient complaint(s); tracking multiple complaints from a given patient associated with multiple body systems/regions; and tracking patient complaints being treated over time; as just a few examples.

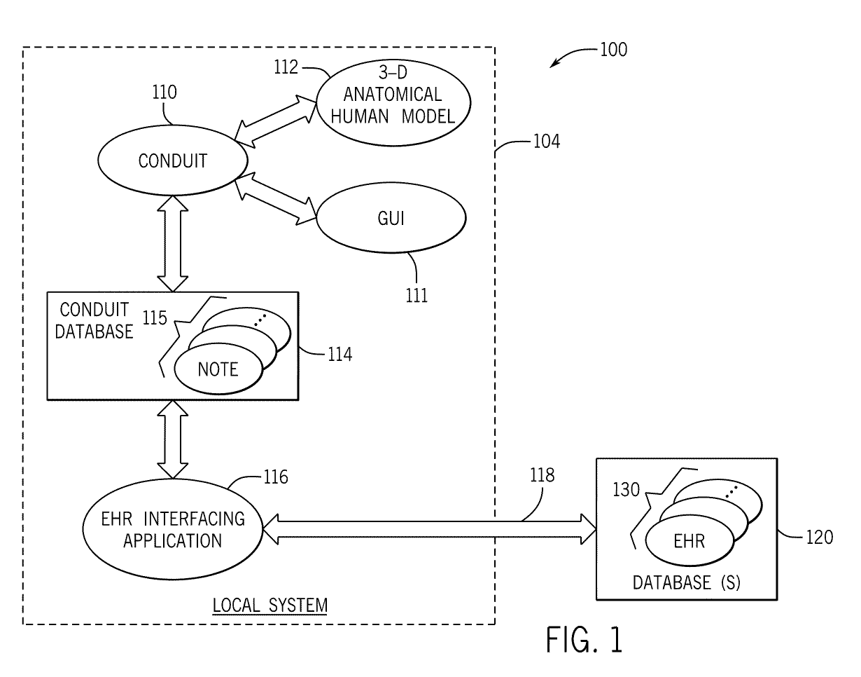

For the example implementation of FIG. 1, the conduit tool 110 is part of a local system 104. As examples, in accordance with some implementations, the local system 104 is a processor-based system (i.e., a system containing at least one central processing unit (CPU), microcontroller, or processing core that executes machine executable instructions, or “software”). The conduit tool 110 may be, in accordance with example implementations, a software application that is executed by one or more CPUs of the local system 104. For implementations in which the local system 104 is a processor-based system, the conduit tool 110 configures the system 104 to be a specific physical machine that is constructed to be used, as described herein, to document a patient encounter and generate/update an EHR in response thereto.

The conduit tool 110 may be, as examples, be a portable, or hand-held electronic device, such as a tablet, a portable computer or a smartphone; a thin client; a desktop computer; and so forth. Thus, many variations are contemplated, which are within the scope of the appended claims.

As illustrated in FIG. 1, in accordance with example implementations, the conduit tool 110 uses a local conduit database 114 for purposes of controlling interaction with the GUI 111, forming the GUI 111; forming the model 112; generating/forming/storing notes 115 (SOAP notes, for example); generating/updating EHRs; and, in general, acquiring and documentation associated with patient encounters. The database 114, in general, is a data store, which stores digital data for the model 112, GUI 111, EHRs, notes 115 and so forth, depending on the particular implementation. In accordance with some implementations, the database 114 may organized, at least in part, as a relational database that may be accessed via schema, further described herein. However, the database 114 may be another database type (a graph-based database, for example), in accordance with further example implementations.

As depicted in FIG. 1, the conduit database 114 may be coupled to an EHR interfacing application 116 for purposes of formatting data in the appropriate format to communicate with (transmit EHRs to and receive EHRs from) an EHR database 120, which stores EHRs 130. In accordance with example implementations, the EHR interfacing application 116 may synchronize with the EHR database 120 pursuant to a synchronization schedule, when prompted by the clinician interacting with the GUI 111, when an update to an EHR occurs and/or when an EHR is generated. As depicted in FIG. 1, in accordance with example implementations, the EHR database 120 is separate from the local system 104 and may be remotely disposed with respect to the local system 104. Moreover, the EHR database 120, in general, represents, one or multiple databases that are operatively coupled together (at local and/or remote locations relatively to each other) to store EHRs.

In general, the EHR interfacing application 116 may communicate with the EHR database 120 over network fabric 118 that contains various gateways, routers, switches and so forth, as can be appreciated by one of ordinary skill in the art. Communication between the EHR interfacing application 116 and the EHR database 120 may thus involve one or more of the following (as examples): wifi communication links, wired Ethernet communication links, local area network (LAN) communication links, cellular data communication links, Bluetooth communication links; wide area network (WAN) communication links; Internet-based communication links, and so forth.

As will become apparent in the following discussion, the local system 104 may have additional components that are not specifically illustrated in FIG. 1, in accordance with example implementations. For example, the local system 104 may have display to display the GUI images; sensors (capacitance touch sensors, a camera, and so forth) to acquire input from the clinician; other input devices (a mouse, a keyboard, etc.); and so forth, as can be appreciated by one of ordinary skill in the art.

A primary use of the conduit tool 110, in accordance with example implementations, is to chart a patient's visit during an initial or follow up consultation. Specifically, in accordance with example implementations, the conduit tool 110 meets one or more of the following goals: supports charting without losing face time with the patient; allows for quick charting relative to a patient's symptoms; allows for quick charting relative to the indicated area of complaint; allows for partial charting of a visit with the ability to edit the chart later after the patient leaves the clinician's office; enhances the patient's visit by using the conduit tool 110 as a visualization tool while discussing the patient's complaint; and provide a tool that works in alignment with the way the clinician works.

Other and different goals may be met using the conduit tool 110, depending on the particular implementation. For example, in accordance with further example implementations, the conduit tool 110 may be distributed in variety of versions, each customized to specifically address one particular medical field. Each version, in these example implementations, leverages the GUI and 3-D anatomical view of the human body to enhance one or more of the work flows that are particular to the field. For example, a surgeon may have different needs than a family practitioner, but the surgeon each might gain from the view and streamline approach provided by conduit tool 110, albeit at different levels of resolution and with different user interface demands, than are discussed in the examples herein.

In accordance with example implementations, the conduit tool 110 may execute, or run, as an extension to an EHR by allowing the clinician to chart a patient's visit from the point of view of the anatomy most closely associated with the patient's complaint. When working with the conduit tool 110, the clinician first identifies the part of the body affected and charts from that reference point. However, the clinician is not obligated to identify that part explicitly, as the clinician may identify a given part implicitly by the symptom or suspected diagnostic condition of the patient.

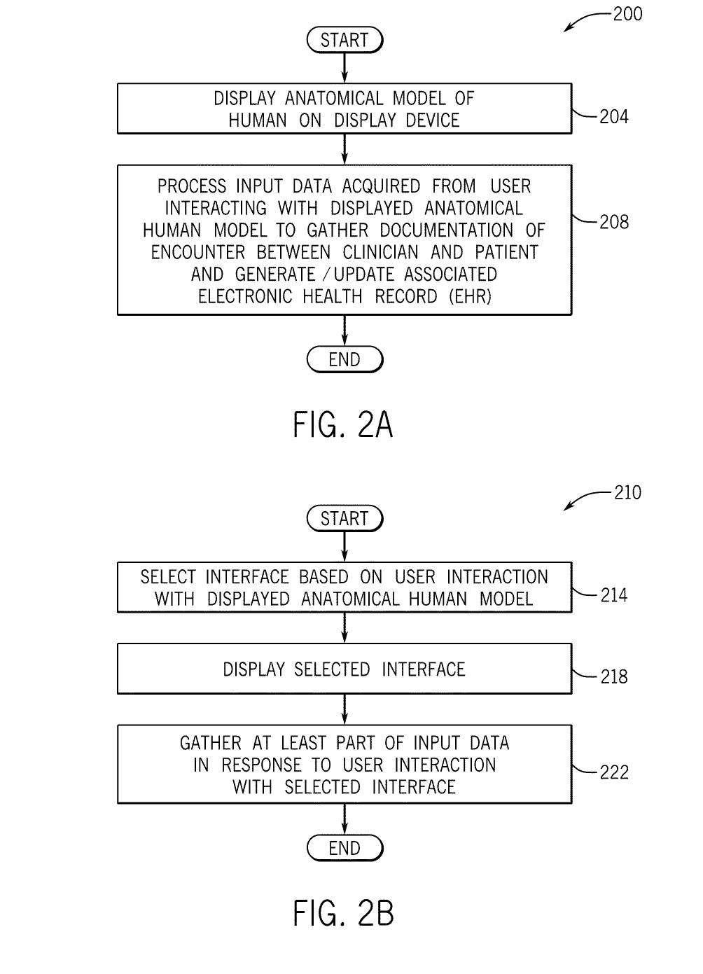

Thus, referring to FIG. 2A, in accordance with example implementations, a technique 200 includes displaying (block 204) an anatomical model of a human on a display device and processing (block 208) the input data acquired from a human user (the clinician or assistant acting under directions from the clinician, for example) interacting with the displayed anatomical human model to gather documentation of an encounter between the clinician and a patient and generate/update an associated EHR. More specifically, referring to FIG. 2B, as further described herein, a technique 210 includes selecting (block 214) an interface based on user interaction with a displayed anatomical human model and displaying (block 218) the selected interface. Pursuant to the technique 210, at least part of the processed input data is gathered (block 222) in response to user interaction with the selected interface.

The conduit tool 110 provides a list of symptoms that can be used to quickly reference a part of the body and start the charting process. Each symptom in the list is associated with a particular part or system of the body as represented in the model. A symptom may be identified by the patient or by the attending clinician. When a symptom is selected, the associated body part or system is highlighted in the model and the charting process begins.

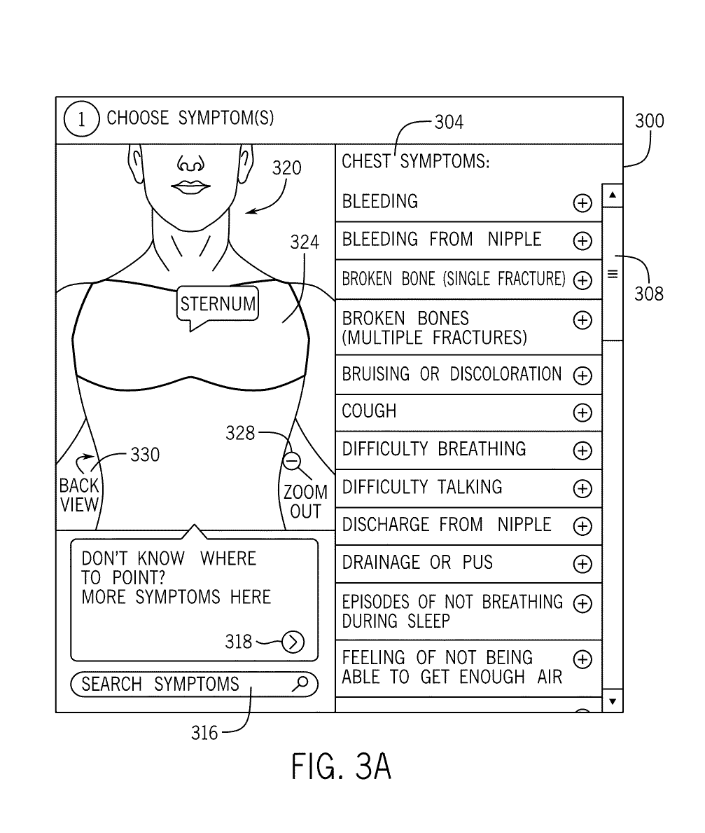

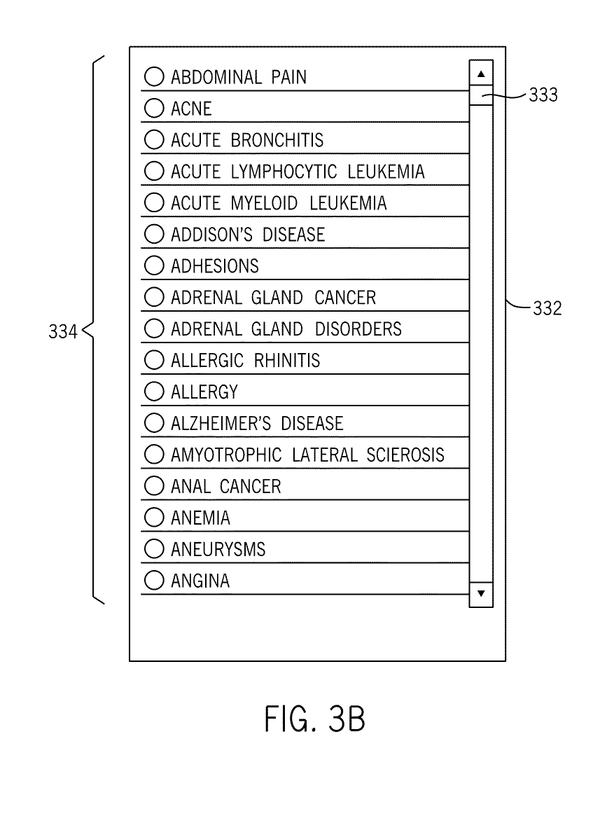

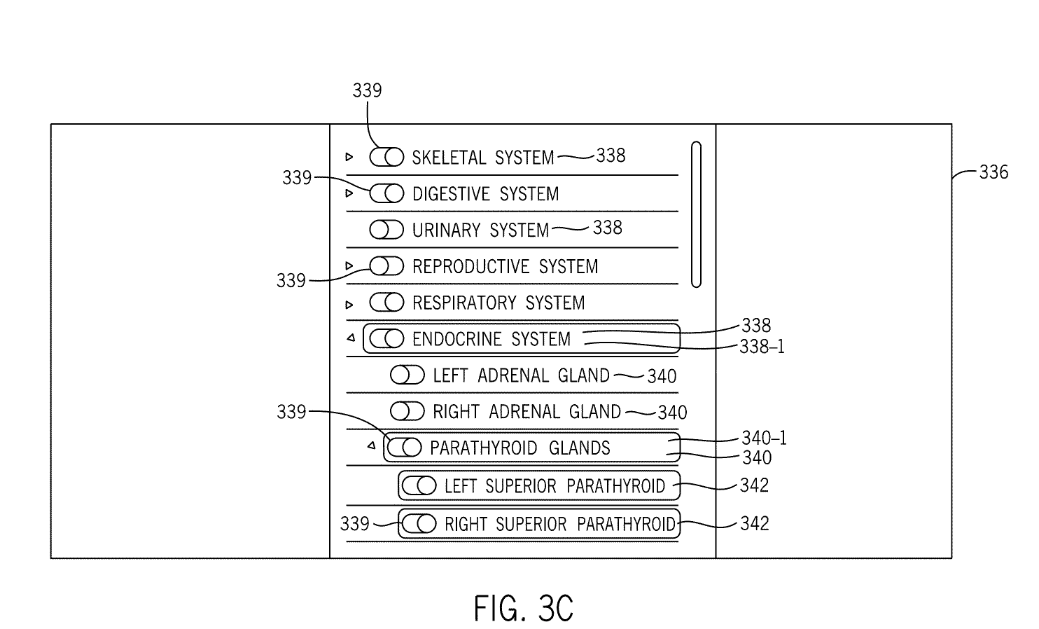

FIG. 3A depicts an example window 300 that may be displayed on the GUI 111 (FIG. 1) for purposes of selecting symptoms. For this example, an upper portion of a 3-D body map 320 (i.e., a 3-D anatomical human model image) shows that through interaction with the GUI 111, the clinician has selected the sternum 324. As a result of this selection, the GUI 111 displays chest symptoms 304. As illustrated in FIG. 3A, the clinician may move a scroll bar 308 for purposes of scrolling through the specific chest systems 304 that are displayed in the window 300. A given symptom 304 may be selected from the list by selecting (touching the screen, “clicking” a mouse, and so forth) the appropriate selector that is associated with the symptom 304. FIG. 3A also illustrates that a rotation icon 330 may be selected for purposes of rotating the body map 320 for a back view; and a zoom icon 328 may be selected for purposes of zooming out on the body map 320. A corresponding zoom in icon for zooming in on the model 320 may also appear when zooming in is allowed, in accordance with further example implementations. Moreover, as depicted in FIG. 3A, the window 300 may provide a button selector 318 for guidance, or help, in selecting symptoms and a search input text box 316 for purposes of using a search engine of the conduit tool 110 to search for symptoms.

The conduit tool 110, via the GUI 111, provides a list of diagnostic conditions that may be used to quickly reference a part of the body and begin the charting process. Each condition in the list is associated with a particular part or system of the body as represented in the model. A condition may be speculated by either the patient or by the attending clinician as a possible match to the symptoms seen. When a condition is selected, the associated body part or system is highlighted in the model and the charting process begins.

As an example, FIG. 3B depicts a window 332 that may be displayed by the GUI 111 showing diagnostic conditions 334, which may be used to quickly reference a part of the body. A bar selector 333 may be used for purposes of scrolling through conditions 334 displayed in the window 332. In this manner, a given circle selector may be selected for purposes of selecting a corresponding condition 334.

In accordance with example implementations, the conduit tool 110 provides a tree view of the anatomy within the model. This tree view may be used to select systems or individual body parts within a system. In this manner, in response to the clinician selecting a piece, or portion, of anatomy in the tree view, the GUI 111 highlights that part in the model. Body systems may also be selected. In response to the clinician selecting a system in the tree view, the GUI 111 highlights all anatomy associated with that system. After the tree selection is made, the charting process may then begin, in accordance with example implementations.

FIG. 3C depicts an example tree view window 336 that may be displayed by the GUI 111. The window 336 may display systems 338 and individual body parts 340. As shown in FIG. 3C, the systems 338 and body parts 340 may be selected using slide selectors 339, in accordance with example implementations. For the specific example of FIG. 3C, the window 336 shows selection of the endocrine system 338-1, which causes the GUI 111 to display glands of the endocrine system. Moreover, for the specific example of FIG. 3C, the parathyroid glands 340-1 have been selected, which causes the GUI 111 to display left superior and right superior parathyroid glands 342.

To support the goal of providing clinicians with a tool that aligns with the way they work, the conduit tool 110 divides the skin of the model into a set of selectable areas, which represent a high level dissection of the body. As can be appreciated by the clinician, these selectable areas are generally referred to by patients when the patients discuss their complaints.

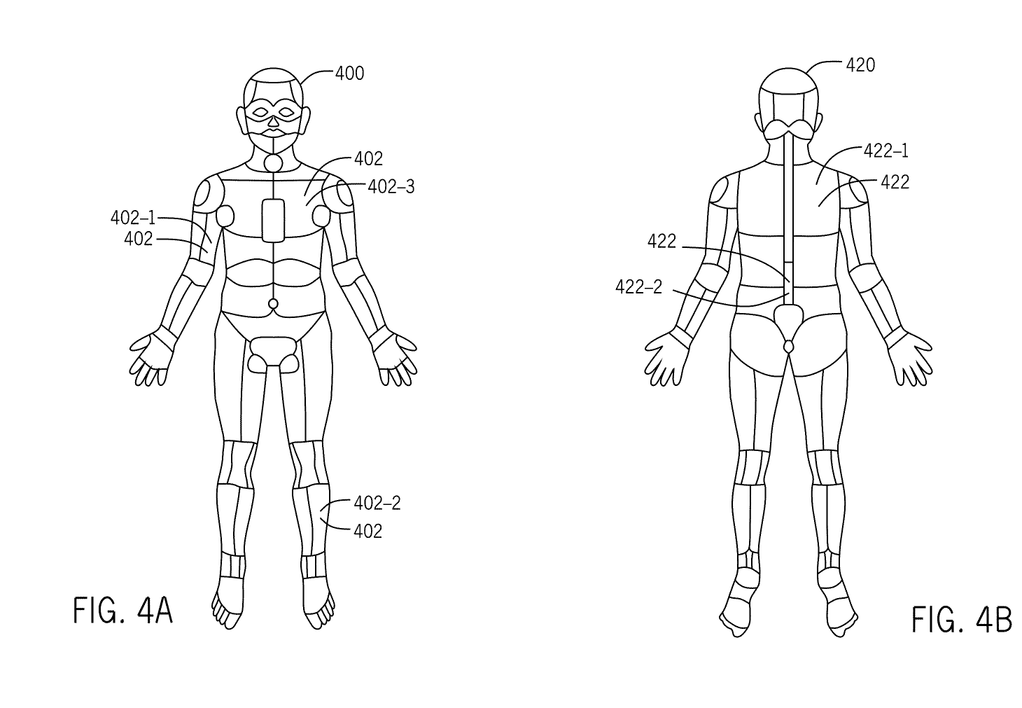

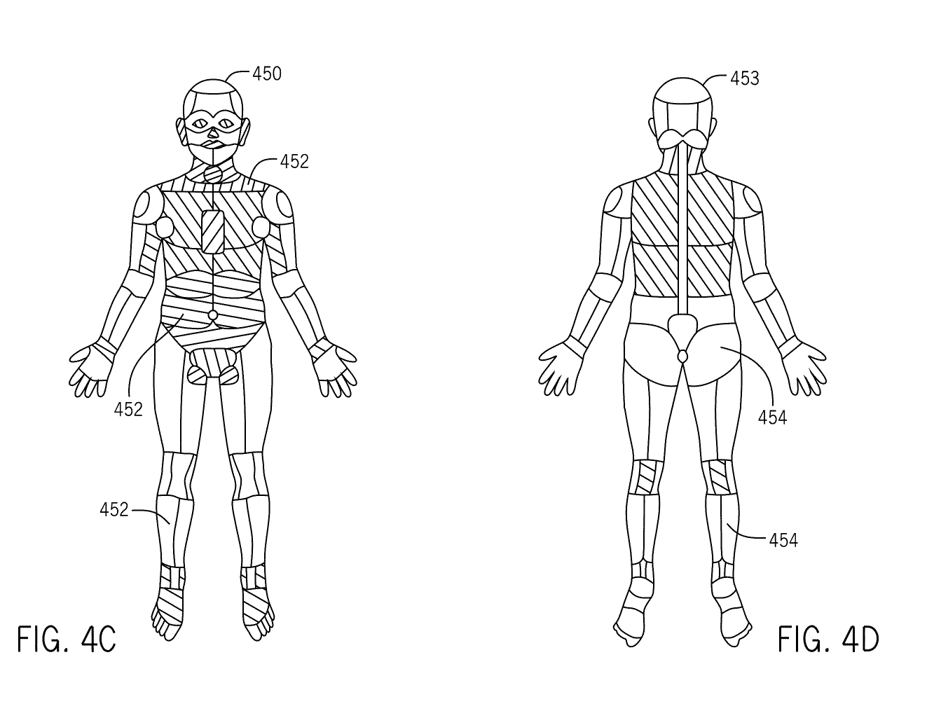

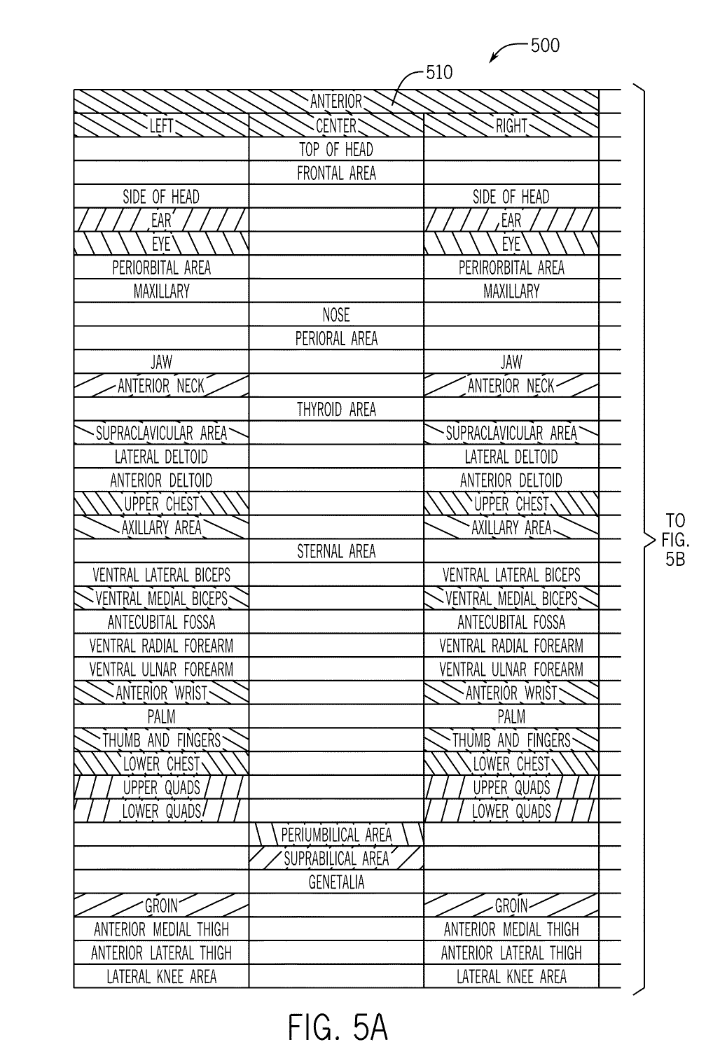

In accordance with example implementations, the conduit tool 110 breaks up the skin of the model into areas that are depicted in the GUI 111 as anterior and posterior body map images for purposes of allowing the clinician to select the appropriate area in response to corresponding patient complaint(s). These skin body map images are also referred to herein as “skin maps.” In accordance with example implementations, the GUI 111 is constructed to display an anterior skin map 400 (FIG. 4A) and a posterior skin map 420 (FIG. 4B). As depicted in FIG. 4A, the anterior skin map 400 has various defined areas 402 of the skin (such as the medial biceps area 402-1, the anterior fibular area 402-2, and the upper chest 402-3, as a few examples). In a similar manner, the posterior skin map 420 also has various defined areas 422 (such as the right upper back 422-1 and the lumbar spine area 422-2, as just a few examples).

In accordance with example implementations, there may be 156 specific areas of the skin, which are represented in the anterior 400 and posterior 420 skin maps. Moreover, the anterior 400 and posterior 420 skin maps may be 3-D images, in accordance with example implementations

In accordance with example implementations, via the GUI 111, the conduit tool 110 graphically color codes the skin breakdown according to the symptoms generally associated with each area. In this manner, referring to FIGS. 4C and 4D, in accordance with example implementations, the conduit tool 110 provides a color-coded skin map that contains corresponding skin map areas 452 and a color-coded skin map 452 that contains corresponding skin areas 454. In accordance with example implementations, the skin areas that incur the same symptoms are generally assigned the same color. The charting process and use the use of the skin maps allows the clinician to capture the symptoms of a complaint after the area of the complaint has been selected. To do this, the clinician interacts with the displayed skin map to select from a predefined list of symptoms that is displayed for the selected area of the skin map.

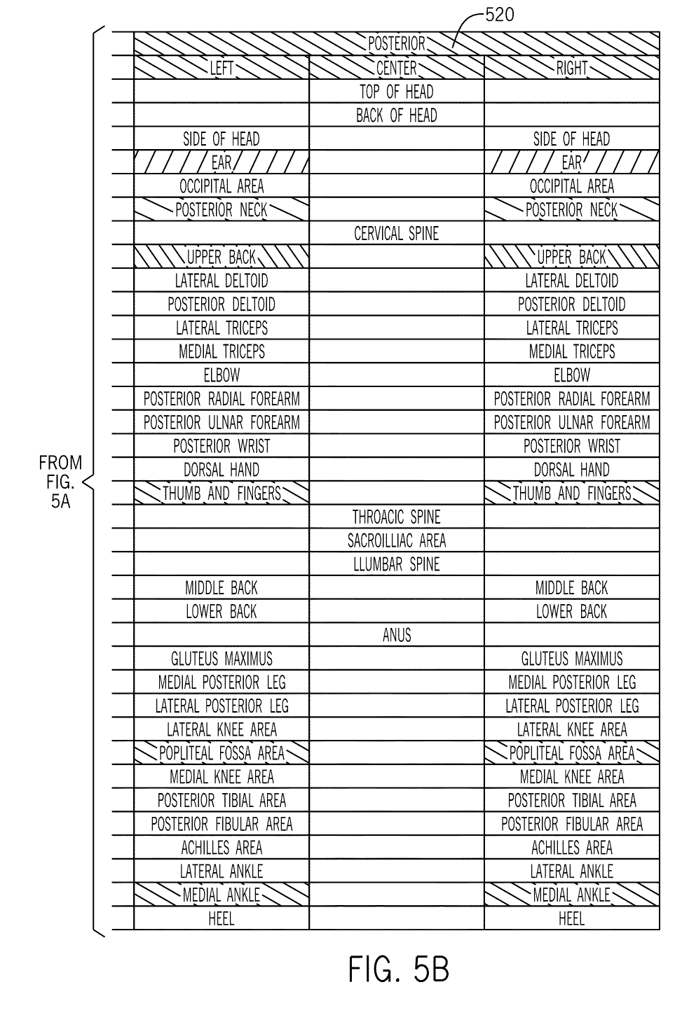

FIGS. 5A and 5B is an illustration 500 of a spreadsheet depicting the anterior and posterior skin map areas with their respect symptom color, in accordance with example implementations. In this manner, FIG. 5A illustrates a color coding 510 for the anterior skin map, and FIG. 5B illustrates a color coding 520 for the posterior skin map, in accordance with example implementations.

In accordance with example implementations, the skin maps that are used by the conduit tool 110 may be created using a modeling application like Maya® from Autodesk. Adding intelligence to the model can be achieved, in accordance with example implementations, using an application such as Unity 3D. The result is a set of data that is stored in the local system 104 (FIG. 1) to form at least part of the model 112 (FIG. 1).

As a more specific example, in accordance with some implementations, the skin maps that are used by the conduit tool 110 may be created as follows. First, two skin-only models (one male and one female (skin only) are created. In accordance with some implementations, the GUI 111 may display child skin maps, as well. Therefore, creating the skin maps may involve creating male and female adult skin models, as well as create male and female child skin models. The models may be created using Maya, in accordance with example implementations.

Next, groups of polygons within each model are assigned to respective areas of the model, such as the areas depicted in FIGS. 5A and 5B. In accordance with example implementations, the assignments are kept alongside the model as metadata. The assignments may be performed using texture maps such that one map is created for each body area and applied to the model in Maya.

A “call back” is then created for the conduit tool 110, serving as the notification that a polygon and more specifically, an area of the skin map has been selected. When a polygon within the model is selected, the call back determines which area has been selected by querying the texture map on the polygon. A call back notification may be accomplished, for example, using a mesh collider.

The conduit tool 110 is next configured to highlight a given area of the skin map when the area is selected. Configuring the conduit tool 110 to highlight may be accomplished by changing the texture coloration of the mesh, in accordance with example implementations.

The mapping between the areas defined by the skin map and the symptoms in the symptom list that are common to each area may then be mapped. In accordance with example implementations, the conduit tool 110 applies a filter that restricts the list of possible symptoms that can be associated with a complaint based on the area of the skin map that has been selected. The conduit tool 110 may perform this filtering using database schema, as further described below.

A mapping is created between the conditions in the conditions list and the symptoms in the symptoms list. This mapping identifies a condition by the symptoms that are associated with it. The conduit tool 110 may perform this mapping using database schema, as further described below.

Finally, the skin map may be associated with markers called “PINs” herein (and further described below), which are opened in the GUI 111 when an area (a 3-D area, for example) of the skin map is selected. In accordance with example implementations, the creation of the PINS for the conduit tool 110 may be accomplished using, for example, a popover window.

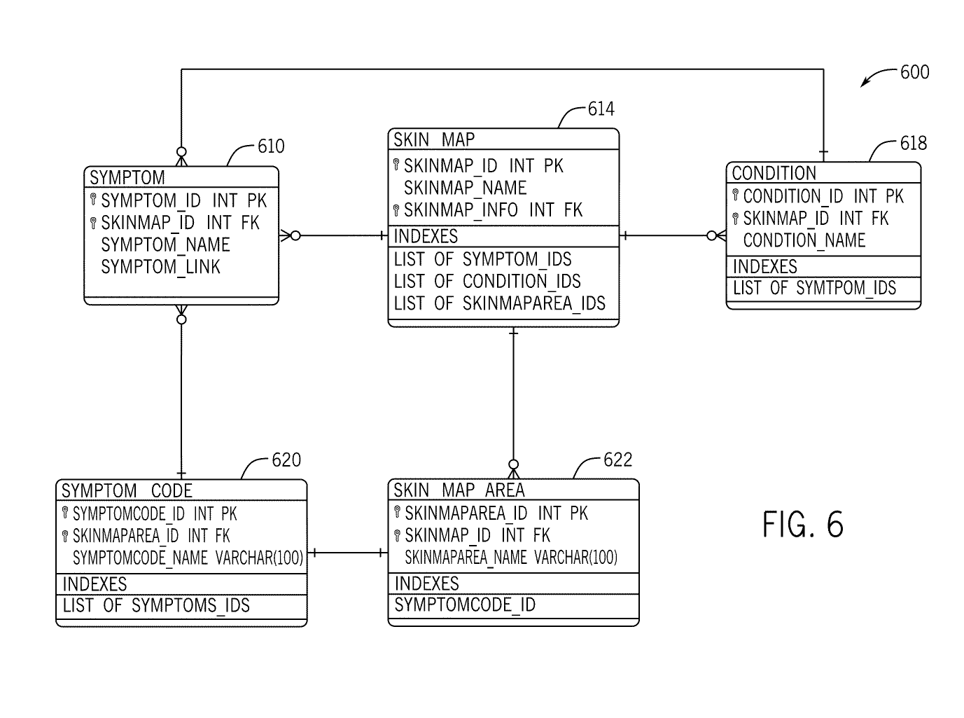

FIG. 6 depicts example schema 600 that is used by the conduit tool 110 to define relationships between the skin maps (schema 614), the skin map areas (schema 622), symptoms (schema 610), symptom codes (schema 620) and conditions (schema 618), in accordance with example implementations.

When working with a skin map in the GUI 111, the clinician may follow these steps (in accordance with an example implementation). The clinician selects the patient's complaint area on the skin map. The clinician may then create a PIN for the selected complaint area, with a list of common symptoms/complaints being associated with the area (as highlighted by the GUI 111).

As described further below, a selection from the PIN menu opens a view in the detail area of the screen that will allow creation of a SOAP note from the genre selected in the PIN list of associated symptoms/complaints. In accordance with example implementations, when a sufficient number of symptoms have been charted, the conduit tool 110 posts a potential condition under a diagnosis tab of the PIN.

The conduit tool 110 allows the clinician to work in any of several modes. In a first mode, the clinician may explicitly identify and select the complaint location at a very detailed and anatomically correct level. This mode takes advantage of the model preciseness and navigability provided by the conduit tool 110. Both the 3-D anatomical human model image and the master tree view image provided by the GUI 110 support this mode, in accordance with example implementations.

In another mode, the clinician may work from a symptom or suspected condition to identify a location and then use the conduit tool 110 to begin the charting process.

In another use of the conduit tool 110, the clinician may work in a mode that's appropriate when the initial conversation with a patient is at a general level that does not directly point to some specific anatomy, but instead gives a general indication of the location of the complaint's origin. This represents the place where the patient hands off his complaint to the clinician for professional assessment. The skin map supports this mode of operation.

Often, when the clinician first begins talking with a patient he/she may want to work with the model from this generalized segmented skin map and dive down from there as needed for more precision. This is because patients generally discuss their complaints from this this vantage point to begin with.

As noted above, the PIN is a marker that is displayed as part of the GUI 111 and identifies a pointer of interest on the anatomical human model. In this manner, the conduit tool 110 uses the PIN to identify a point of interest, i.e., the location of a complaint.

The purpose of the PIN in the conduit tool 110 is to provide a relative location for the clinician to initiate the charting of a complaint. The PIN provides a set of complaints/symptoms common for the area selected on the model. Selecting one of these open the detail area of the screen for entering the charting data associated with the history, physical exam, diagnosis and plan of a complaint. In accordance with example implementations, a PIN may be created, deleted, edited or relocated to another part of the human anatomical model.

In accordance with example implementations, a PIN has two display modes: an expanded mode and a collapsed mode. In the expanded mode, the entire PIN (i.e., the entire dialog window) is displayed and is active in the GUI 111 for purposes of soliciting clinician input. The expanded mode is used when selecting a symptom/complaint, as further described herein. The expanded display mode of the PIN is illustrated in example PINs 7A, 7B, 7C, 7D and 7E, which are further described below. In the collapsed display mode of the PIN, only the title bar of the PIN is possibly displayed, in accordance with example implementations. In the collapsed display mode, the PIN is not being used for charting.

In accordance with example implementations, the conduit tool 110 supports two pinning modes. In the first pinning mode, conduit tool 110 creates the PIN in response to the clinician explicitly clicking or touching a part of the anatomical human model that is displayed in the GUI 11 to create and place the PIN. In another pinning mode, the conduit tool 110 implicitly creates and places a PIN in response to the clinician identifying a part of the anatomical human model by one of the following actions: choosing the part through the master tree view; selecting a body area in the skin map; selecting a symptom in the symptom list (which automatically selects the location associated with the symptom); and selecting a potential condition in the condition list (which automatically selects the location associated with the condition). This, second, implicit pinning mode for generating a PIN may be the mode most likely to be used by a clinician when charting a patient, in accordance with example implementations.

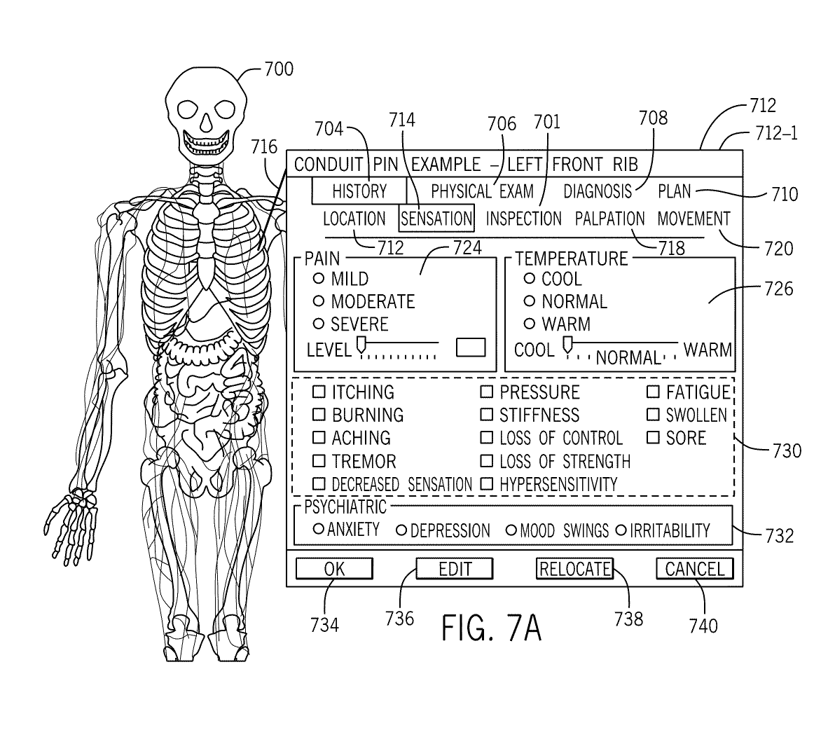

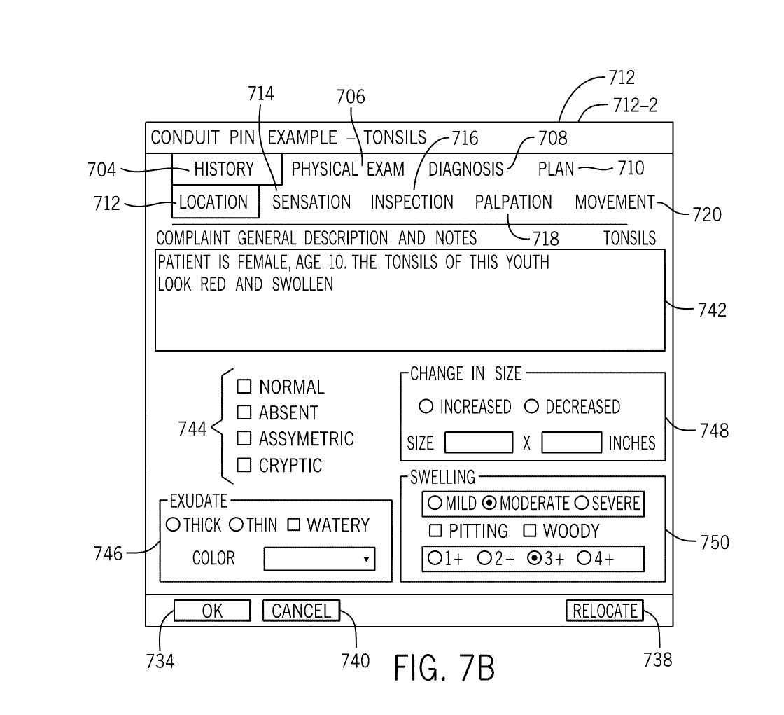

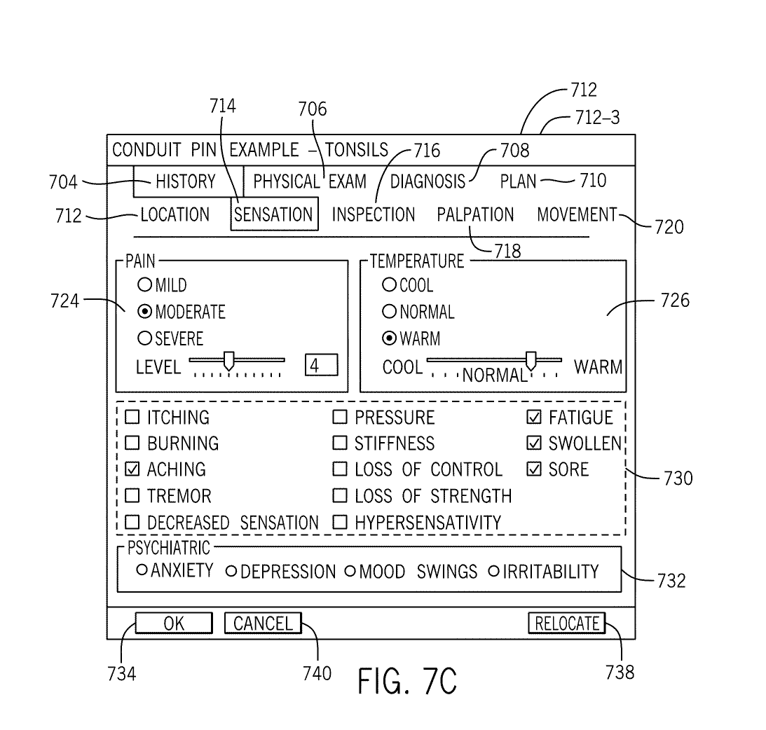

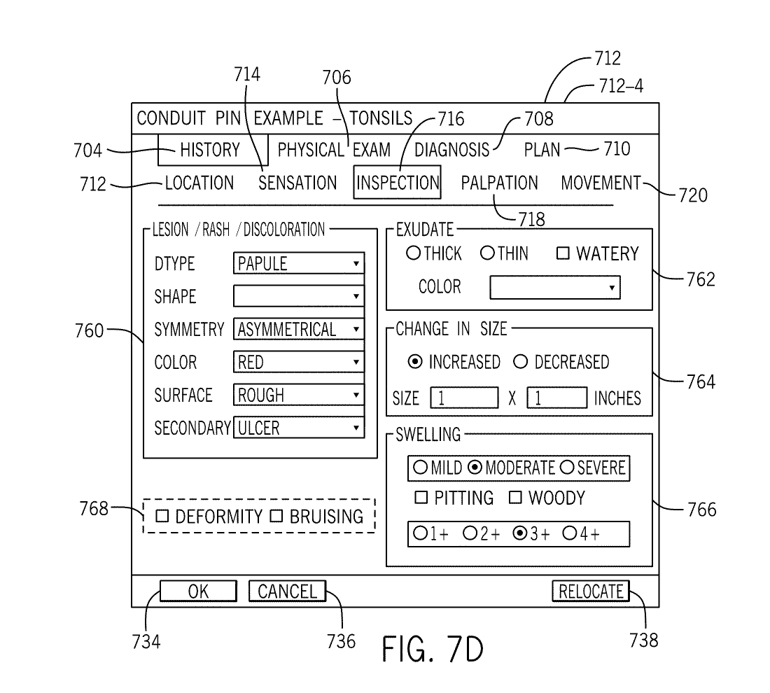

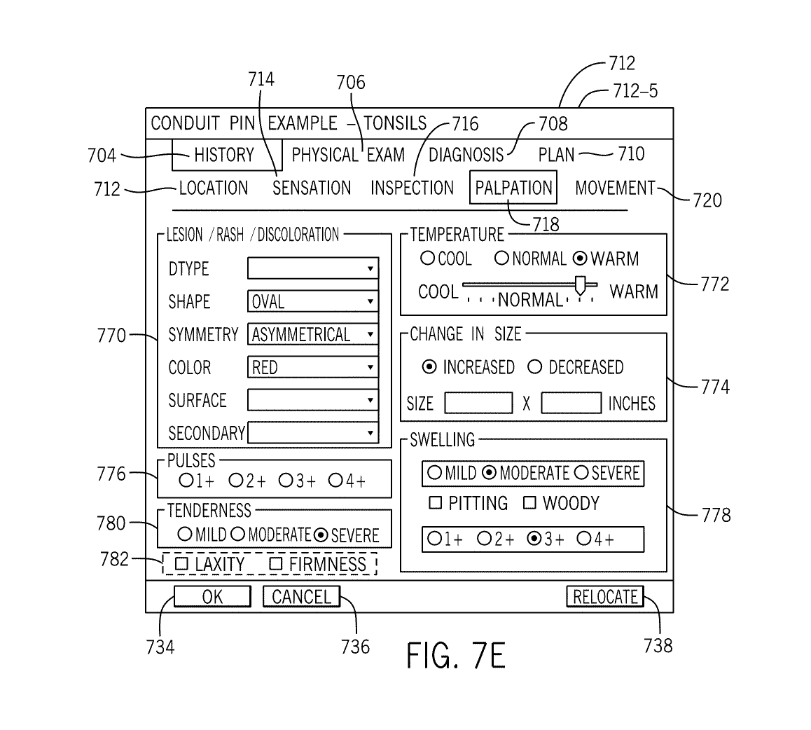

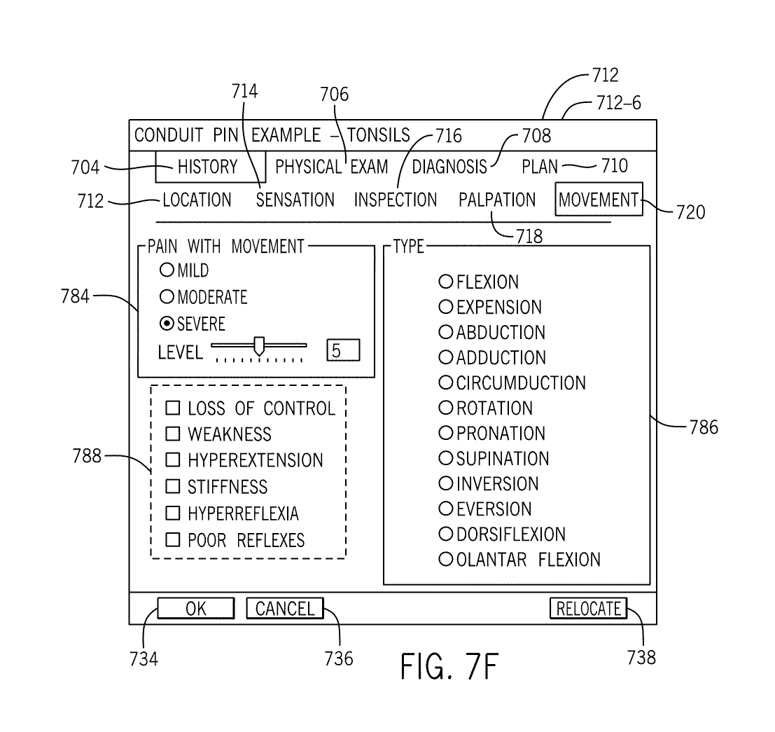

FIG. 7A depicts an example PIN dialog box, called a “PIN window 712,” in accordance with some implementations. For this example, the PIN The PIN window 712 is a PIN window 712-1 that is associated with a left front rib of an anatomical human model 700, as indicated by an associated arrow 701 connecting the PIN window 712-1 with the left front rib. The PIN window 712-1, model 700 and association arrow 701 are displayed by the GUI 111.

The title bar of the PIN window 712-1 displays the location 715 of the complaint (here, the “left front rib”). The title bar serves to identify the PIN 712-1 (and its associated complaint) for future reference when the PIN has been collapsed and only the title bar is visible. The end of the association arrow 701 closest to the body part may be used to move the PIN from one body part to another. This function may be achieved, in accordance with some implementations, by using a relocation button 738 of the window 712-2.

The PIN window 712 further includes an OK button 734 that collapses the PIN window 712 down to just the title bar and an edit 736 button, in accordance with example implementations. The PIN window 712 further includes a cancel button 740, which allows the PIN to be closed without saving any edits made after the PIN window 712 was opened. The cancel button 740 may also be used to reverse the creation of a PIN that was made in error. As noted, the edit button 736 may be visible, in accordance with example implementations, when the PIN is collapsed. Pushing on the edit button 736 expands the PIN window 712 for charting.

The relocate button 738 is used to place the PIN in relocation mode, which allows movement of the PIN. In this manner, after depressing the relocate button 738, the clinician is free to move the end of the association arrow 701 closest to the body part currently associated with the PIN. The clinician may then drag and drop that point onto the new body part to be associated with the PIN.

Beneath the title bar of the PIN window 712, there are two tab menu rows, in accordance with example implementations. These rows are used to specify the chart to be edited by the clinician. In accordance with example implementations, the first row contains four tabs identifying four areas of charting for the complaint: a history tab 704, which is selected to chart, or enter, information describing the history of the complaint from the patient's point of view; a physical exam tab 706, which is selected to enter information describing the physical examination that is conducted by the clinician; a diagnosis tab 708, which is selected to enter information describing the diagnosis that is made by the clinician; and a plan tab 710, which is selected to enter information describing the treatment plan that is prepared by the clinician.

The conduit tool 110 dynamically adjusts which menu tabs are displayed on the second row based on the selection made in the first row. As illustrated in FIG. 7A, for the history tab 704 selection, the corresponding menu tabs for the second row are as follows: a location tab 712, which is selected to chart elements particular to the body part or system associated with the PIN; a sensation tab 714, which is selected to chart the complaint from the general sensory aspects explained to clinician by the patient; an inspection tab 716, which is selected to chart the complaint from the visual aspects that are explained to the clinician by the patient; a palpation tab 718, which is selected to chart the complaint from the skin sensory aspects explained to the clinician by the patient; and a movement tab 720, which is selected to chart the complaint from the body movement aspects explained to the clinician by the patient.

The selection of the menu tabs of the second row control which charting panels are displayed by the conduit tool 110 in the PIN window 712 below the second row. For the example PIN window 712-1 that is depicted in FIG. 7A in which the history tab 704 and the sensation tab 714 are selected, the following charting panels are displayed: a panel 724 to allow charting of the level of pain expressed by patient to the clinician; a panel 726 to allow charting of a temperature expressed by patient to the clinician; a panel 730 to allow charting of a general sensory condition expressed by patient to the clinician; and a panel 732 to allow charting of a psychiatric state expressed by patient to the clinician.

FIGS. 7B, 7C, 7D and 7E depict example PIN windows 712 for different example charting scenarios when 1. the history tab 704 is selected; and 2. one of the location 712, sensation 714, inspection 716, palpation 718 or movement 720 tabs of the second row of menu buttons is selected. For FIGS. 7B-7E, the PIN windows correspond to examples when the PIN is associated with tonsils (as shown in the title bar). For FIG. 7B, which displays example PIN window 712-2, the location tab 712 is selected, and the following panels are displayed: a panel 742 that includes a text entry box to allow charting of a general description/notes describing the location of the complaint expressed by patient to the clinician; a panel 744 to characterize the clinician's assessment of the location; a panel 746 where the clinician may characterize any exudate; a panel 748 to chart any change in size; and a panel 750 where the clinician may characterize any swelling.

For FIG. 7C, which displays example PIN window 712-3, the sensation tab 714 is selected, and the panels 724, 726, 730 and 732, discussed above for FIG. 7A, are displayed.

For FIG. 7D, which displays example PIN window 712-4, the inspection tab 716 is selected, and the following panels are displayed: a panel 760 to chart information pertaining to a lesion, rash or discoloration; a panel 762 where the clinician may characterize any exudate; a panel 764 where the clinician may note any change in size; a panel 766 where the clinician may chart any swelling; and a panel 768 wherein the clinician may chart any deformity or bruising.

For FIG. 7E, which displays example PIN window 712-5, the palpation tab 712 is selected, and the following panels are displayed: a panel 770 in which any lesion, rash or discoloration may be charted; a panel 772 in which the temperature may be charted; a panel 774 in which the change in size may be charted; a panel 778 in which a swelling may be charted; a panel 780 in which a tenderness may be charted; and a panel 782 in which a laxity or firmness may be charted.

For FIG. 7F, which displays example PIN window 712-6, the movement tab 720 is selected, and the following panels are displayed: a panel 784 allows a pain experienced with movement to be charted; a panel 786 that allows a type of the movement to be charted; and a panel 788 that allows the complaint associated with the movement to be charted.

As noted above, the conduit tool 110 displays other sets of second row menu tabs based on whether the history tab 704, physical exam 706, diagnosis tab 708 or plan tab 710 in the first row is selected. As a further example, in response to the physical exam tab 706 being selected, the conduit tool 110 may display the following tabs for the second row menu: a location tab, which is selected to display panels to chart elements particular to the body part or system associated with the PIN; an inspection tab, which is selected to display panels to allow the clinician to chart the complaint from the visual aspects seen by the clinician; a palpation tab, which is selected to display panels to allow the clinician to chart the complaint from the skin sensory aspects that are felt by the clinician; and an “other evaluations” tab; which is selected by the clinician to display panels to chart the complaint from the other aspects that are perceived or collected by the clinician.

In a similar manner, the conduit tool 110 is constructed to display other sets of second row menu tabs and corresponding panels in response to selection of the diagnosis tab 708 or plan tab 710 of the first menu row.

As examples, conduit tool 110 may supports one or more of the following use cases for purposes of documenting a patient encounter and generating/modifying the corresponding EHR. A patient, waiting in the lobby, is called, enters the visitation room, and the nurse initiate the encounter. In this manner, the nurse walks into the visitation room to see the patient. The nurse picks up a tablet computer that serves a platform (for this example) for the conduit tool 110, which is connected to the practice's EHR for the patient. The nurse interacts with the conduit tool 110 via its GUI 111. The nurse logs into the conduit tool 110 and therefore into the practice's EHR. The nurse identifies the patient in the conduit tool 110 and starts the encounter. The conduit tool 110 syncs with the practice's EHR and imports the patient identification (ID). The nurse enters the date of visit. The nurse asks patient what he/she is being seen for and enters that as a text note into conduit tool 110. The nurse takes patient vitals and enters the vitals into the conduit tool 110. The nurse locks the conduit tool 110. The patient encounter remains intact.

Next, the clinician enters the visitation room. The clinician picks up the tablet computer platform for the conduit tool 110, as left by the nurse, and the clinician unlocks the conduit tool 110. The clinician resets conduit tool 110 so that the skin map is displayed on the GUI 111. The clinician reviews the note left by the nurse and reviews vitals taken by nurse.

The complaint location is next identified. The patient identifies his complaint relative to a general area of the body. In this manner, clinician identifies the general area of the complaint using the conduit tool 110. The identification of the general area of the complaint may be accomplished in one of two ways, in accordance with example implementations. In this first way, the clinician may touch the general area on the skin map that is displayed on the GUI 111. Alternatively, the clinician may select the general area from the master tree view that is displayed in the GUI 111 by the conduit tool 110.

Next, the patient identifies his complaint relative to a specific system part or system of the body. The clinician identifies that part or system in the conduit tool 110. This can be done in one of two ways, in accordance with example implementations. In the first way, the clinician touches that part or system on the more detailed anatomical human model that appears below the skin map in the GUI 111. Alternatively, the clinician selects that part or system from the master tree view in the GUI 111.

The patient then identifies his complaint relative to a symptom. In this manner, the patient identifies the main symptom of his/her complaint. The clinician selects the symptom from the symptom list in the GUI 111 if the symptom is in the list. The conduit tool 110 is constructed to highlight a specific system or part of the body as associated with the symptom and therefore the complaint.

The patient then identifies his/her complaint relative to a condition. The clinician or the patient makes a pre-diagnosis and identifies the suspected condition underlying the patient's complaint. The clinician selects the condition from the condition list that is displayed in GUI 11 if the condition is in the list. The conduit tool 110 is constructed to highlight a specific system or part of the body as associated with the condition and therefore the complaint.

The clinician is then ready to create a PIN is created for the complaint. A PIN for the complaint is created in either of two ways. Following any of the uses, a PIN is implicitly and automatically created and associated with the part of the body identified by one of those use cases. This implicit creation may be occur, for example, through selection of an area of the skin map or through selection of part of the body's underlying anatomy. Using the pinning tool that is provided by the conduit tool 110, the clinician may alternatively explicitly create a PIN.

After its creation, the PIN is displayed so that information pertaining to the complaint may be charted by the clinician. Upon creation, the PIN's dialog box, or window, defaults to the charting panels associated with the history and location tabs being selected (see, for example, FIG. 7B). From here, the clinician may do one of three things: 1. cancel the PIN by selecting the cancel tab, which destroys the PIN since it was a newly created PIN and not an existing PIN being edited; 2. approve the PIN by selecting the OK button, which collapses the PIN window but leaves the PIN intact; or 3. begin entering data into the PIN's charting panels.

Next, the clinician charts the patient visit using the PIN window. In the case where the clinician has decided to enter data in the PIN, he does so now. The clinician is free to move between any of the history tabs while collecting data, but usually goes from left to right through the tabs in the following sequence: location tab; sensation tab; inspection tab; palpation tab; and movement Tab. The clinician completes charting and closes the PIN by selecting the OK button on the PIN interface.

The clinician may edit a given PIN to update a patient's chart at later time after the patient leaves. In this manner, the clinician is not obligated to enter all documentation about a complaint at any given time, and the clinician may create a PIN, close it, then come back to it at another time to chart the patient information. Thus, the conduit tool 110 supports editing of an existing PIN. To perform the editing, the clinician identifies the PIN that holds the chart the clinician desired to modify. The clinician selects that PIN in the GUI 111 by clicking, tapping or pushing on it. The clinician pushes the edit button on the PIN window, and in accordance with example implementations, the PIN window opens to the charting panel with the data that was entered in that panel. The clinician completes his/her updates and closes the PIN by selecting the OK button on the PIN window.

The clinician may relocate a given PIN to a different body part. In this manner, the clinician is not obligated to identify the exact location of a complaint at any given time. The clinician may create a PIN at a location, close the PIN, and then wish to refine the location associated with the PIN at another time. In accordance with example implementations, the conduit tool 110 supports relocation of an existing PIN. To perform the relocation, the clinician identifies the PIN to be relocated, selects that PIN in the GUI 111 by clicking, tapping or pushing on it. The PIN window then expands. One way for the clinician to complete the relocation is for the clinician to push the relocate button and drag the PIN window to the new location. Other way for the clinician to complete the relocation is for the clinician to the “anatomy end” of the association arrow for the PIN to piece of the anatomy that it is associated with. After relocating the PIN, the clinician may close the PIN by selecting the OK button on the PIN window.

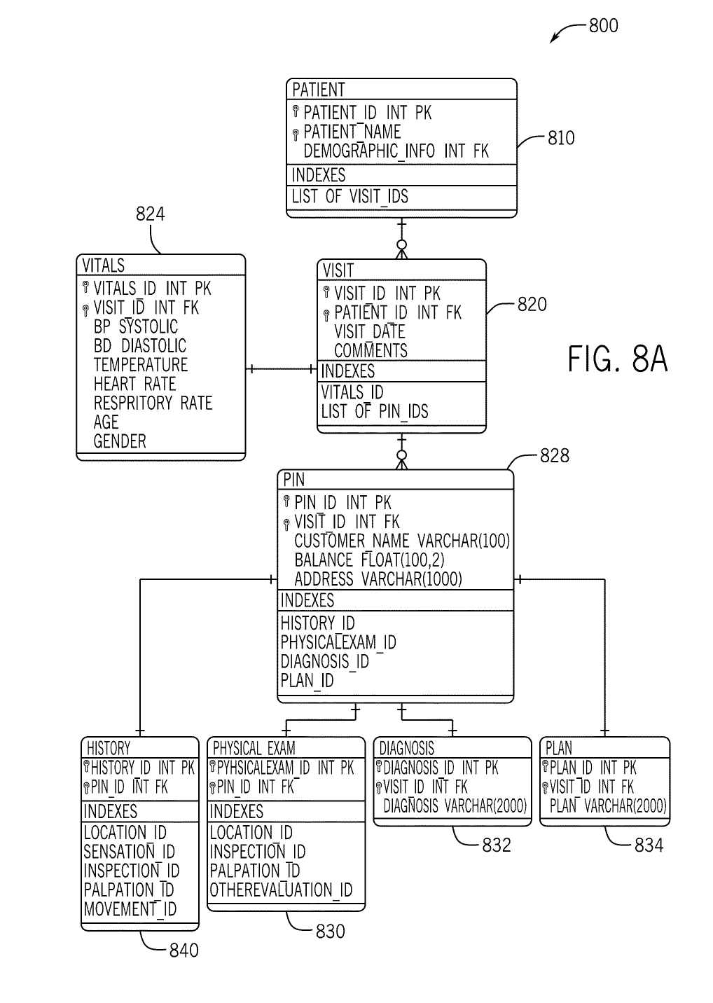

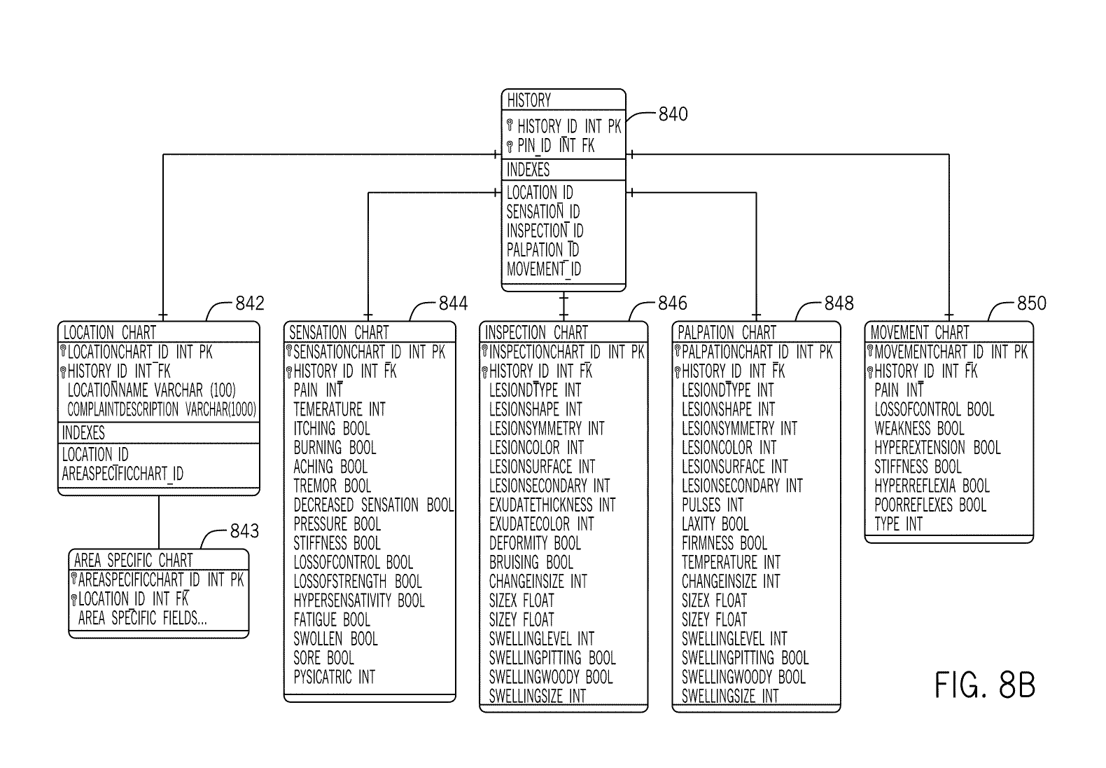

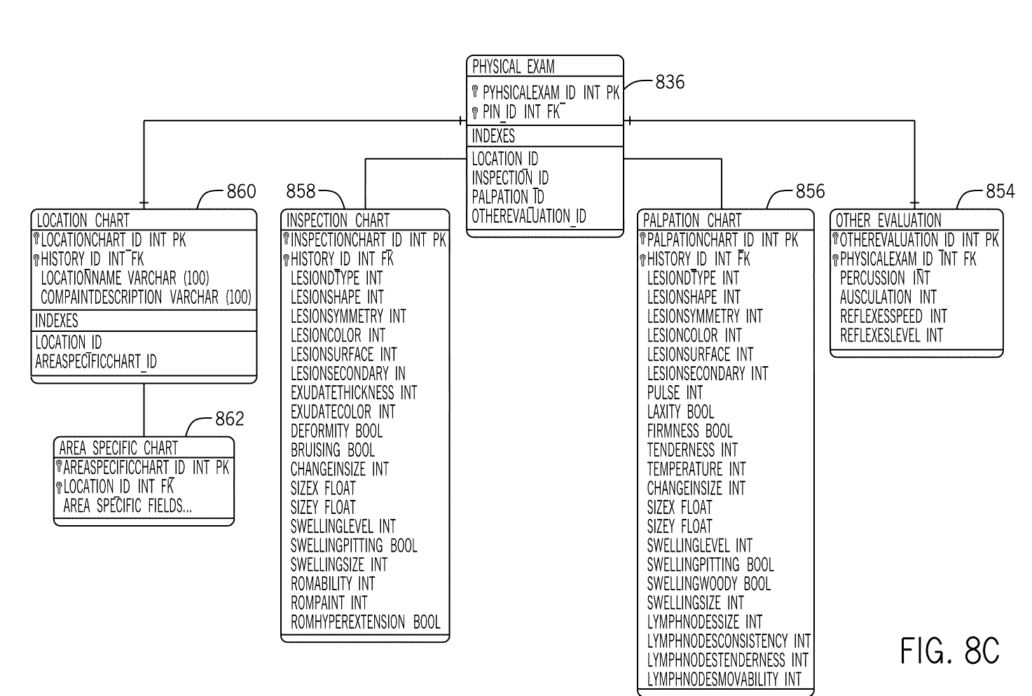

Referring to FIGS. 8A, 8B and 8C, in accordance with example implementations, the conduit tool 100 may use schema 800 in connection with the PINS. Referring to FIG. 8A, in particular, the schema includes patient schema 810 relating to patient names, demographics, indexes to last visits, and so forth; visit schema 820 relating to visit dates, associated PIN IDs with visits, and so forth; vitals schema 824, such as systolic blood pressure, diastolic blood pressure, temperature, heart rate, and so forth; and PIN schema 828. Moreover, the PIN schema 828 may be connected to various PIN features, such as history tab schema 840; physical exam tab schema 836; diagnosis tab schema 832; and plan tab schema 834.

Each of the PIN tab schema may be connected to corresponding charting panel schema. For example, referring to FIG. 8B, in accordance with example implementations, the conduit tool 110 has the following charting panel schema associated with the history tab schema 840: location chart schema 842, sensation chart schema 844, inspection chart schema 846, palpation chart schema 848 and movement chart schema 850. Moreover, the location chart schema 842 is associated with area specific chart schema 843. Referring to FIG. 8C, in accordance with example implementations, the conduit tool 110 has the following charting panel schema associated with the physical exam tab schema 836: location chart schema 860, inspection chart schema 858, palpation chart schema 856 and other evaluation schema 855. Moreover, the location chart schema 860 is associated with area specific chart schema 862.

The diagnosis tab schema 832 and plan tab schema 834 also associated charting panel schema, in accordance with example implementations.

In accordance with example implementation, the conduit tool 110, via the GUI 111, may further display a timeline, which is an easily scrollable mechanism for finding a past visit. Each node on the timeline represents a visit made by the same patient that is being seen currently. When the clinician slides over to a node, the clinician is presented with all the PINs of that visit. Some useful ramifications may be one or more of the following. The clinician may see how a complaint or condition has progressed over time. Frequency of complaints or conditions can be identified. Frequency of drug prescriptions can be identified. Other and different advantages are contemplated, in accordance with the many potential implementations.

Further implementations are contemplated, which are within the scope of the appended claims. For example, in accordance with further example implementations, the PIN window (a charting panel, for example) may include a button for initiating the taking of photographs by the camera of the platform (a camera of a tablet, for example) that hosts the conduit tool 110. In this manner, using this mechanism, the conduit tool 110, via the GUI 110, may allow the clinician to take photographs and store the photographs as part of the chart data for later viewing.

In accordance with example implementations, the conduit tool 110 may display an age and gender appropriate 3-D anatomical model for the patient.

In accordance with example implementations, the conduit tool 110 may select and provide a clinician with a candidate set of symptoms based on interaction of the clinician with a 3-D anatomical human model that is displayed by the conduit tool 110. For example, in accordance with example implementations, the clinician may touch, press or otherwise select a portion of the 3-D anatomical human model, and in response to the selection, Conduit may display a set of candidate symptoms for purposes of allowing the clinician to further document the appropriate symptoms.

In accordance with example implementations, the 3-D anatomical human model allows the clinician to select certain parts of the model and expand the parts. For example, in accordance with example implementations, by a clinician selecting a particular part of the 3-D anatomical human model using the GUI 111, the conduit tool 110 responds by displaying a more detailed and/or internal 3-D model (also herein called a “child model” herein) of the original 3-D parent model in the GUI 111. The child model may be more anatomically detailed than the parent model. As a more specific example, the clinician may select the left eye of a full body 3-D anatomical model using the GUI 111, and in response thereto, the conduit tool 110 may, via the GUI 111, display a more detailed 3-D anatomical model of the eye, allowing the clinician to further chart information that is specifically directed to the left eye.

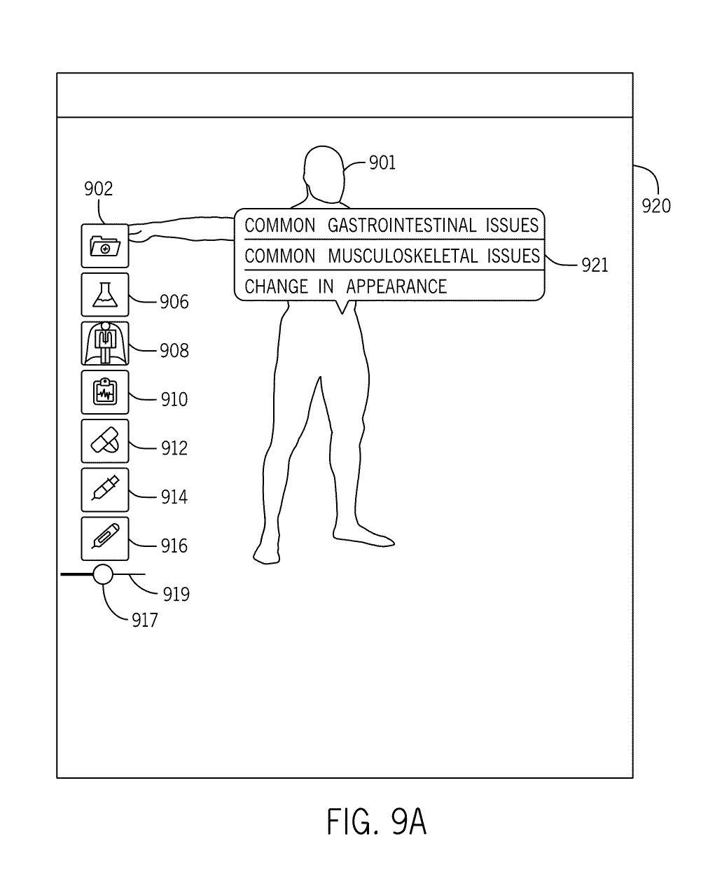

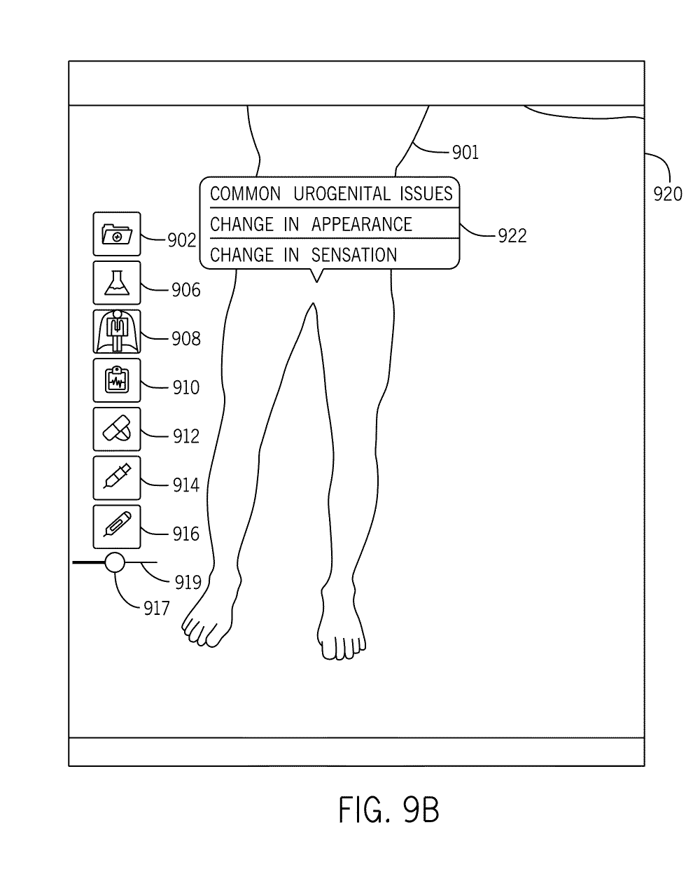

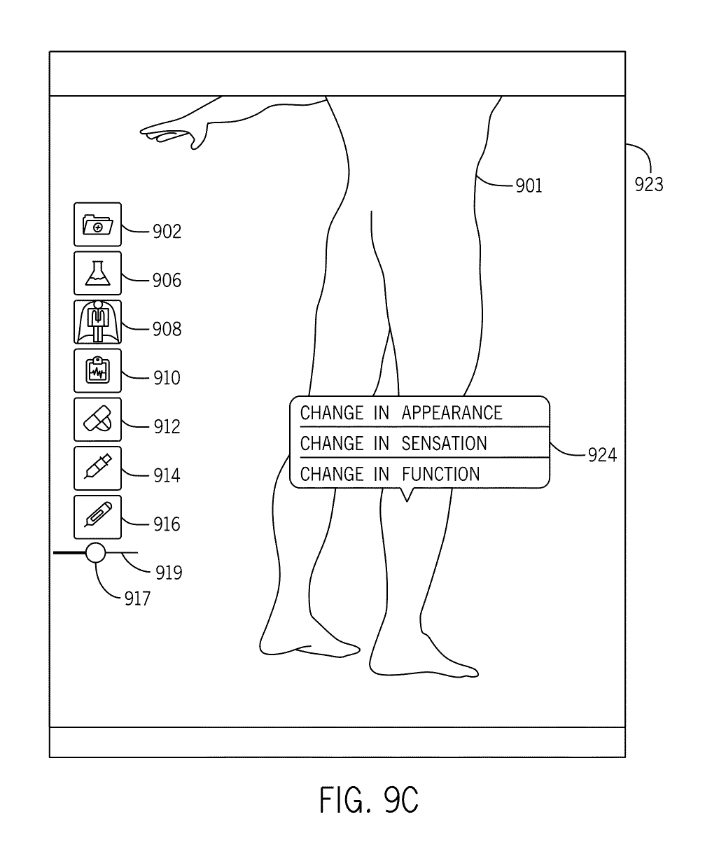

FIGS. 9A, 9B and 9C depict example GUI images displayed on a screen 920 of the physical platform (a tablet, for example), which hosts the conduit tool 110, in accordance with further example implementations. Referring to FIG. 9A, in accordance with example implementations, the conduit tool 110 does not create a PIN window that is filled out by the clinician (as described above) for purposes of creating a corresponding SOAP note. Instead, the conduit tool 110 uses the PIN as a gateway to guide the clinician in creating the SOAP note. In this manner, to initiate the documentation process for a given chief complaint, the clinician may open a new PIN and associate the PIN with a particular part (or skin map area) of the model 901, which is associated with the chief complaint. In response to the creation of the PIN, the conduit tool 110 displays a window 921, which contains a list of candidate symptoms for the selected body part. Thus, the conduit tool 110 filters out potential candidate symptoms that are not associated with the selected body part for purposes of displaying the candidate symptoms that are associated with the selected body part. The clinician may then interact with the window 921 (via selection, scrolling through symptoms, selecting categories and so forth) to select one or more symptoms. In response to the selected symptom(s), the conduit tool 110 may display another window that contains candidate conditions, which are the result of the conduit tool 110 applying filtering in view of the selected area of the skin map and selected symptom(s). The clinician may then select the condition, and in response thereto, the conduit tool 110 displays body parts and/or body systems to further guide the clinician in the charting of the complaint. Moreover, in accordance with example implementations, the conduit tool 110 may guide the clinician through other aspects in generating various aspects of a SOAP note, as described above. Thus, in accordance with these example implementations, the conduit tool 110 guides the entries of the SOAP note, as compared to, for example, the clinician opening tabs of a PIN window, as described above.

FIGS. 9B and 9C illustrated other potential example symptom windows 922 (FIG. 9B) and 924 (FIG. 9B), which are the result of the selection of different areas of the model 901.

As depicted in FIGS. 9A-9C, in accordance with example implementations, the conduit tool 110 may provide a timeline GUI, which allows the clinician to view the one or multiple PINs (and associated SOAP notes) that have been created at a particular time. In this manner, as depicted in FIG. 9A, the timeline GUI includes a timeline bar 919 and a button 917 that may be moved along the timeline bar 919 to selected different times. For each time, the conduit tool 110 displays the PIN(s) for that time. For example, the timeline bar 919 may be in terms of dates, such that each incremental position along the timeline bar 919 represents a different date. For a given selected date, the conduit tool 110 displays the one or multiple PINs for that date. It is noted that in a given visit, a patient may have multiple complaints, and the clinician may create multiple PINs. The clinician may thus use the timeline GUI to rapidly access the SOAP notes pertaining to a particular patient ID and index the viewed notes by date by sliding the button 917.

As also depicted in FIG. 9A, the conduit tool 110 may also, as part of its GUI, display vertical icons, or buttons 902, 906, 908, 910, 912, 914 and 916 on the left-hand side of the GUI image (called the “left buttons” below) to allow the clinician to perform interact with the model 901, as described below. As an example, in accordance with some implementations, the buttons 902-916 may be a charting button 902, a lab test button 906, an imaging scan (x-ray, MRI and so forth) button 908, a virtual desk button 910, a medication button 910, a shot button 914 and a vitals button 916.

The clinician may select left button 902 to pull up separate menus. The clinician may select a button to add (or aid in adding) filtering for the timeline GUI. For example, the clinician may select imaging button 908 and then click on the left knee of the model 901 to filter the timeline for purposes of causing conduit to display records of left knee imaging during the selected time (from March 2010 until the present, for example). As another example, the clinician may click on the shot button 914, another left button, to pull up a procedure menu, which then allows for selection of a procedure (e.g., a flu shot); and then the clinician may click on a specific body area of the model 901 to identify (and thus, also document) which part of the body was involved in the procedure (e.g., show where a flu shot was given, for example).

In accordance with example implementations, the clinician may long press (and/or double click) a body area to pull up a more detailed and/or internal body model (the child model). This process may be repeated to allow the clinician to “drill down” deeper into a given body area with repeated long presses.

In accordance with example implementations, the model 901 may be a 3-D model that may be rotated (as can the “children”) in all axes (all three axes of an orthogonal coordinate system, for example) and resized via touch gestures.

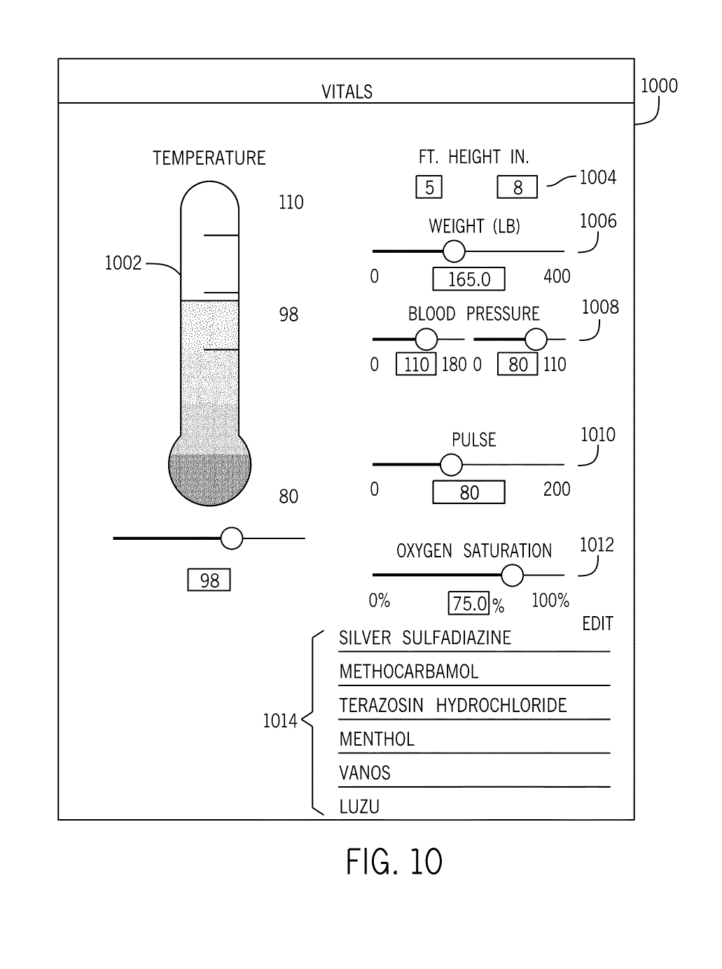

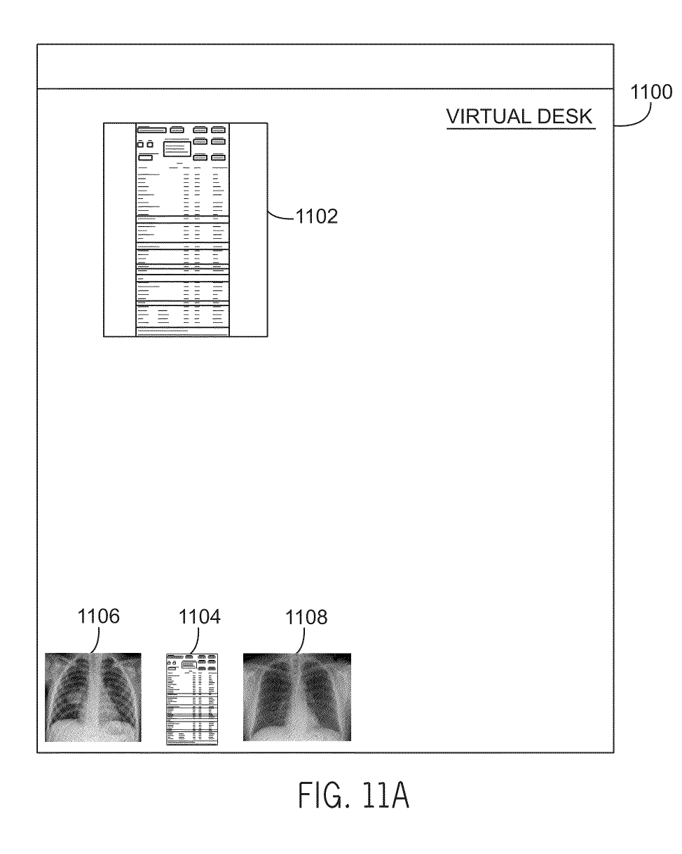

Referring to FIG. 10 in conjunction with FIG. 9A, in accordance with example implementations, the clinician may select the vitals button 916, which causes the GUI 111 to display a vitals dialog box, or window 1000. As shown, the GUI allows the clinician the choice of a number of options entering data, such as (for the example of FIG. 10) the use of a slide bar and associated temperature gauge 1002 for entering temperature; and sidebars/text entry boxes for entering height, weight, blood pressure, pulse rate, and oxygen saturation, as indicated at reference numerals 1004, 1006, 1008, 1010 and 1012, respectively. In accordance with example implementations, one or more of the vital statistics may be automatically updated by the conduit tool 110 using data from connected instruments (a blood pressure machine and/or an oxygen sensor operatively coupled to the physical platform hosting the conduit tool 110, for example. As also depicted in FIG. 10, the vitals screen may contain a panel 1014 for charting prescriptions that affect the vitals.

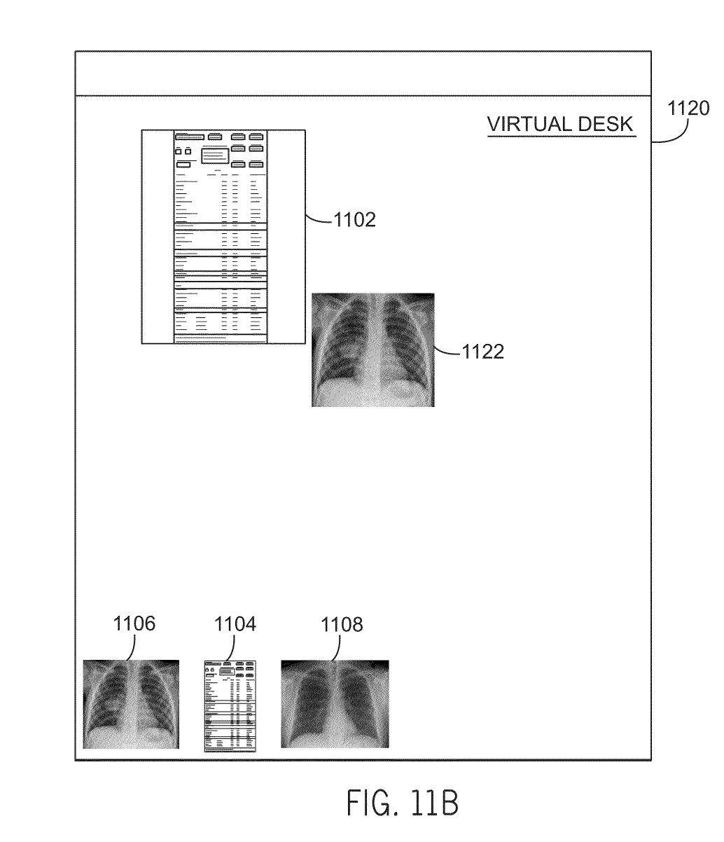

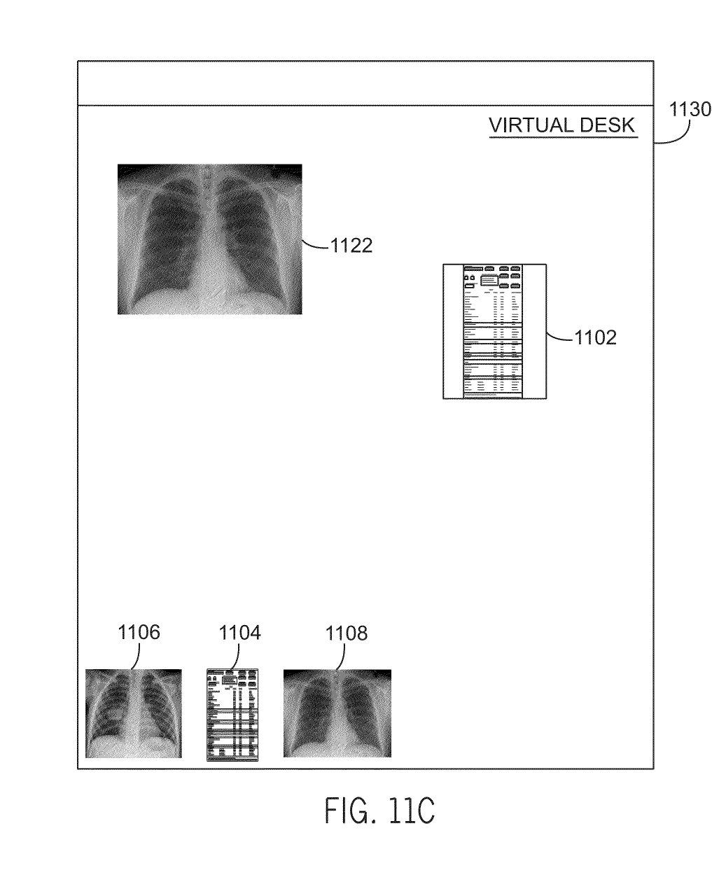

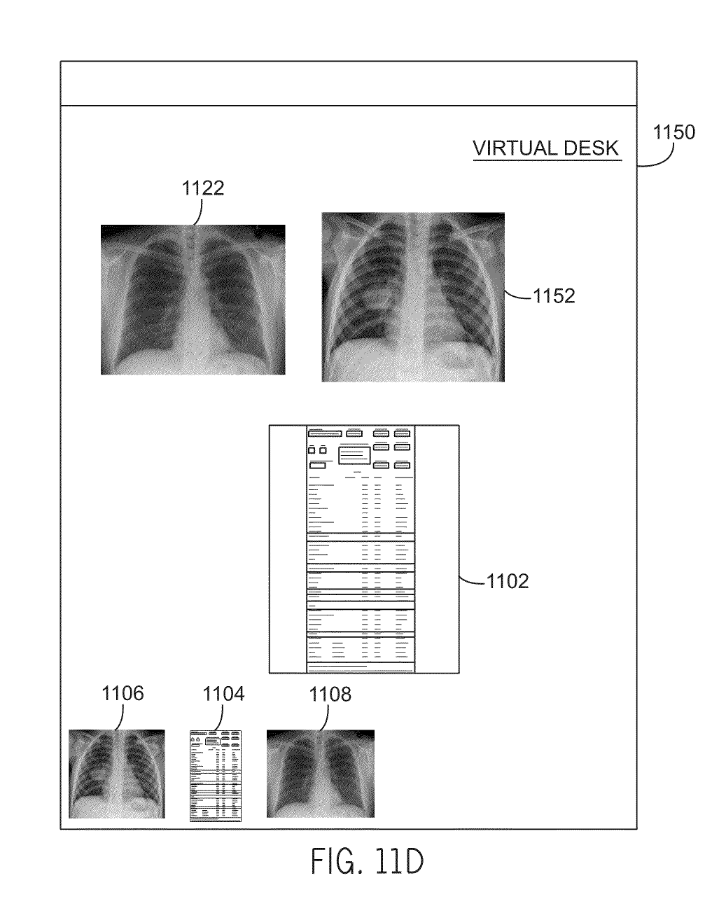

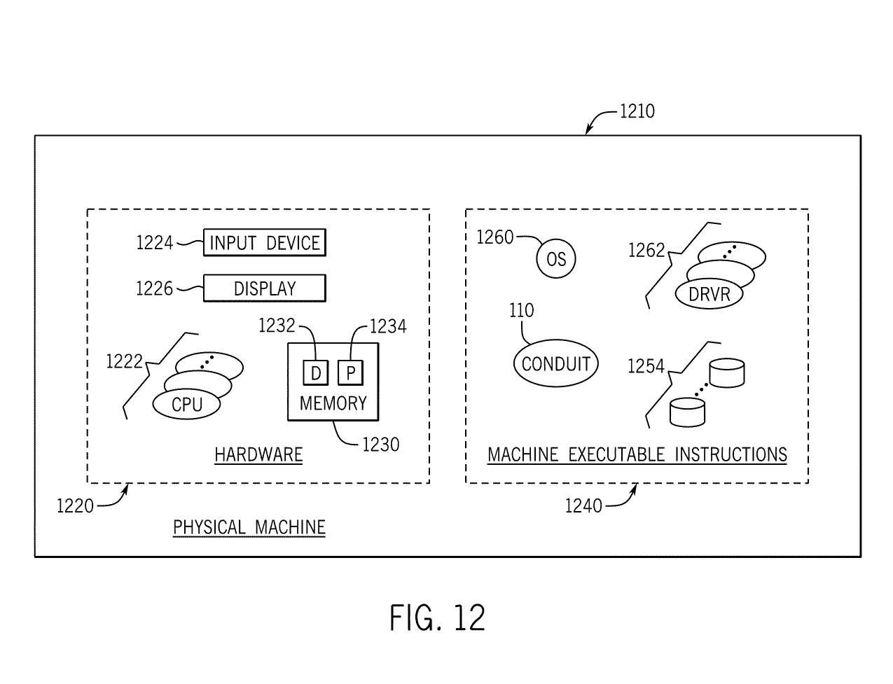

The virtual desk button 910 (see FIG. 9A) allows the selection a virtual desk for the clinician. In this manner, the virtual desk may be used to display 2-D and/or 3-D documents that are associated with the patient and are part of the patient's current medical record and/or past medical history. FIG. 11A depicts an example GUI image 1100 showing the virtual desk. In accordance with example implementations, conduit displays a timeline tool (a timeline tool at the bottom of the display screen, for example). The timeline tool may contain representative icons of files (such as the icons at reference numerals 1104, 1106 and 1108 of FIG. 11A, for example) for potential documents to be displayed, such as X-ray images, chart notes documents, lesion photographs, positron emission tomography (PET) scan images, magnetic resonance imaging (MRI) images, and so forth. The timeline tool may display identifiers depicting specific properties of the files, such as identifiers showing the type of file, the date of the file, and so forth. The clinician may filter the documents for a certain time range, as discussed above.

In accordance with example implementations, the GUI image 1110 has a 3-D space above the timeline tool for viewing/manipulating the documents that are depicted in the timeline tool. Using the timeline tool, the clinician may pull the selected documents into the 3-D space above the timeline tool, move the documents around independently, resize the documents independently, rotate the documents independently, move the documents on top of one another, change transparencies of the documents, and so forth. The clinician may further rotate the entire 3-D field (or world) and resize the entire 3-D field as well, in accordance with example implementations.

The above-described interaction that virtual desk provides tremendous flexibility in viewing documents, especially comparing several documents at once, as can be appreciated by the clinician. The virtual desk allows for simultaneous viewing of 2-D and 3-D images on one screen (such as viewing 3-D PET scan renderings, for example).

FIGS. 11A, 11B and 11C depict example screen images of the virtual desk, in accordance with example implementations. In this manner, FIG. 11A depicts selection of a lab test icon 1104 of the timeline, resulting in the GUI displaying an enlarged corresponding lab test result 1102 in the 3-D space. FIG. 11B depicts the result of the clinician selecting the icon 1106 representing an x-ray, selecting the icon 1108 representing a later x-ray, and then manipulating the corresponding x-rays to overlay one x-ray on another to derive an x-ray image 1122 that highlights changes between the two x-rays. Due to the ability to manipulate document in the 3-D space, the clinician may rotate documents, overlay one document on another, manipulate the layering order of layered documents, manipulate the perspective from which the document is viewed, and so forth. As illustrated in FIGS. 11C and 11D, the documents, may be selectively rearranged and resized, collapsed, expanded and so forth, as desired by the clinician for purposes of reviewing the patient history.

In accordance with example implementations, one or more of the 3-D anatomical models, whether the parent 3-D anatomical model, a child model, and so forth, may be modeled using one or more publically available 3-D models, such as 3-D models available from Turbo Squid or another provider In accordance with example implementations, Conduit may use a graphics rendering engine, such as SceneKit application programming interface (API) provided by Apple Inc.; Swift provided by Apple Inc.; Unity3-D provided by Unity Technologies; Cinema4D provided by Maxon Computer, Inc.; or Cheetah3-D provided by MW3D-Solutions. Other rendering engines/3-D programming platforms may be used by Conduit, in accordance with further example implementations.

In accordance with example implementations, the conduit tool 110 resides on a computer, or processor-based machine, such as physical machine 1210 that is depicted in FIG. 12. In accordance with example implementations, the physical machine 1210 may contain one or multiple central processing units (CPUs) 1222 (one or multiple CPU processing cores, CPU packages, and so forth), which execute machine executable instructions 1240, or “software,” for purposes of providing such software components as the conduit tool 110.

The physical machine 1210 is an actual machine that is made up of actual hardware 1220 and actual machine executable instructions 1240, or “software.” In accordance with some example implementations, the conduit application, as well as possibly other applications, may be hosted by a virtual machine (which executes on physical platform provided by the physical machine 1210).

In addition to the CPU(s) 1222, the hardware 1220 may further include a display panel 1226 or a monitor to display the GUI images describe herein; and at least one input device 1224, such as a stylus, a keypad, input sensors on a display (surface acoustic wave (SAW), capacitive or resistive techniques, for example); and so forth.

The hardware 1220 further includes a non-transitory storage medium, such as a memory 1230. In this manner, the memory 1230 may be formed from non-transitory semiconductor storage devices, optical storage devices, magnetic storage devices, phase change storage devices, resistive storage devices, a combination of any of these devices, and so forth, depending on the particular implementations. As depicted in FIG. 12, the memory 30, in general, may store program instructions 34, which when executed by the CPU(s) 1222 cause the CPU(s) 1222 to form one or more software components, such as the conduit application 50. Moreover, as depicted in FIG. 12, the memory 1230 may also store various data 1232 associated with the execution of the program instructions 1234.

In accordance with example implementations, the conduit tool 110 performs at least some of the techniques that are disclosed herein, such as techniques directed to displaying an anatomical model of a human on a display and using user interaction with the model to gather data representing documentation of an encounter between a healthcare provider and a patient. In addition to the conduit tool 110, the physical machine 1210 may contain other machine executable instructions 1240, such as an operating system 1260, device drivers 1262, databases 1254 used by the conduit tool 110 and possibly other applications, such as the above-described EHR interfacing application 116 (see FIG. 1). The physical machine 1210 may contain other machine executable instructions 1240 that are not depicted in FIG. 12, such as, for example, mappings, metadata, and so forth, as can be appreciated by one of skill in the art.

Although depicted in FIG. 12 as being contained in a single box (or rack), in accordance with further example implementations, the machine 1210 may have a distributed architecture that is distributed among different physical locations. As examples, the machine 1210 may be a tablet, a client, a thin client, a server, a desktop computer, a portable computer or a smart phone, a combination of one or more of these machines, and so forth, depending on the particular implementation.

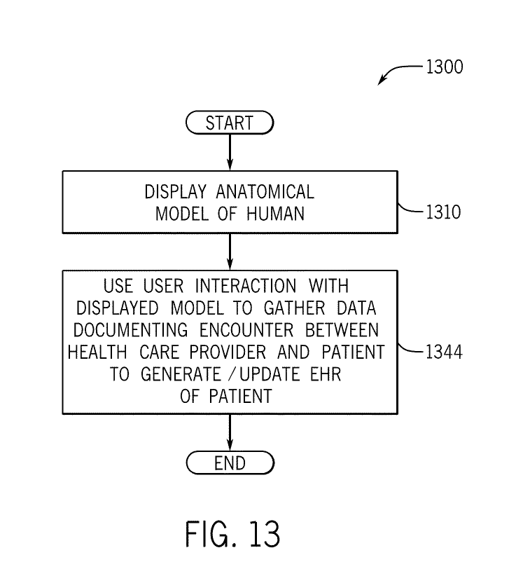

Referring to FIG. 13, thus, to summarize, in general, in accordance with example implementations, a technique 1300 includes displaying (block 1310) an anatomical model of a human and using (block 1344) user interaction with the displayed model to gather data documenting an encounter between a healthcare provider and a patient to generate/update an EHR of the patient.

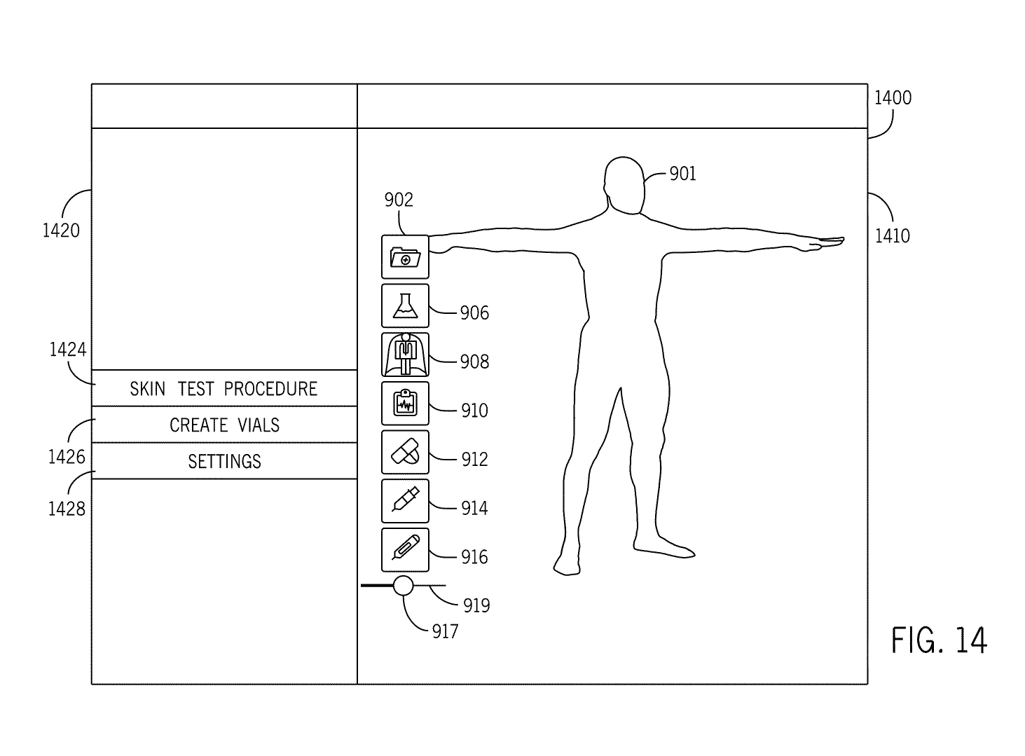

Other implementations are contemplated, which are within the scope of the appended claims. For example, referring to FIG. 14, in accordance with further example implementations, the conduit tool 110 uses a split screen GUI, formed from panels 1410 and 1420. For these example implementations, the conduit tool 110 may have a master view controller that presents a table view in panel 420; detail view controllers that control what is displayed in panel 1410; and a split view controller. Each detail view controller implements a function and informs the split view controller what the detail view controller wants displayed by the master controller in the panel 1420. The master view controller informs the split view controller when something is selected (tapped, for example), so that the corresponding action can be forwarded to the detail view controller or used to load a new detailed view controller. The split screen GUI may have multiple sections, and each detail view controller may have a custom title bar, in accordance with example implementations.

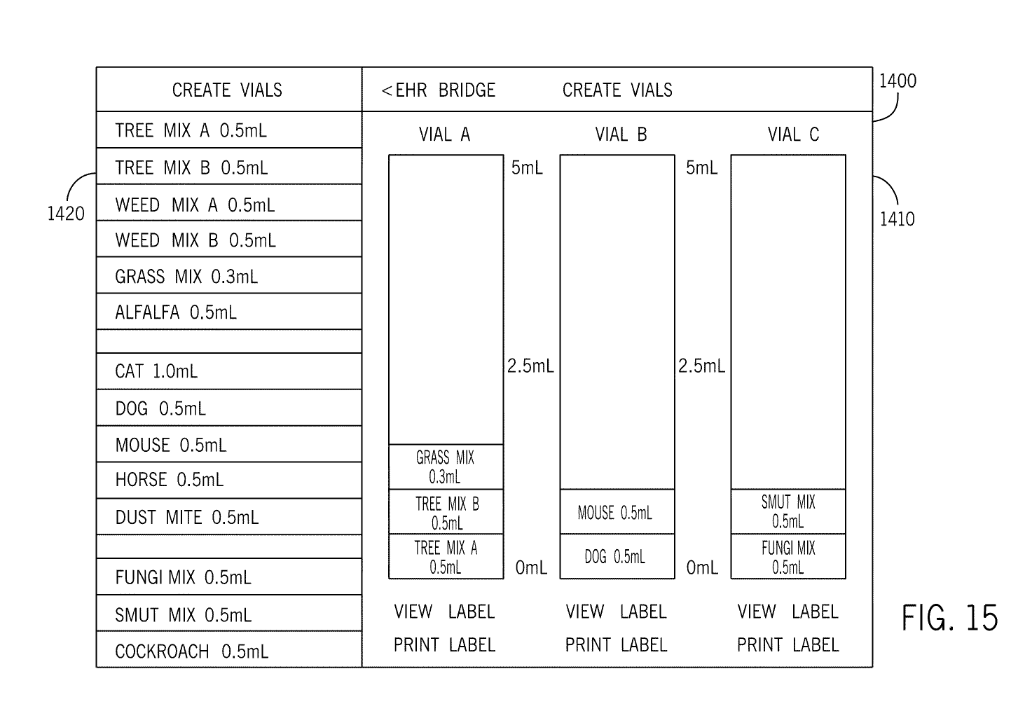

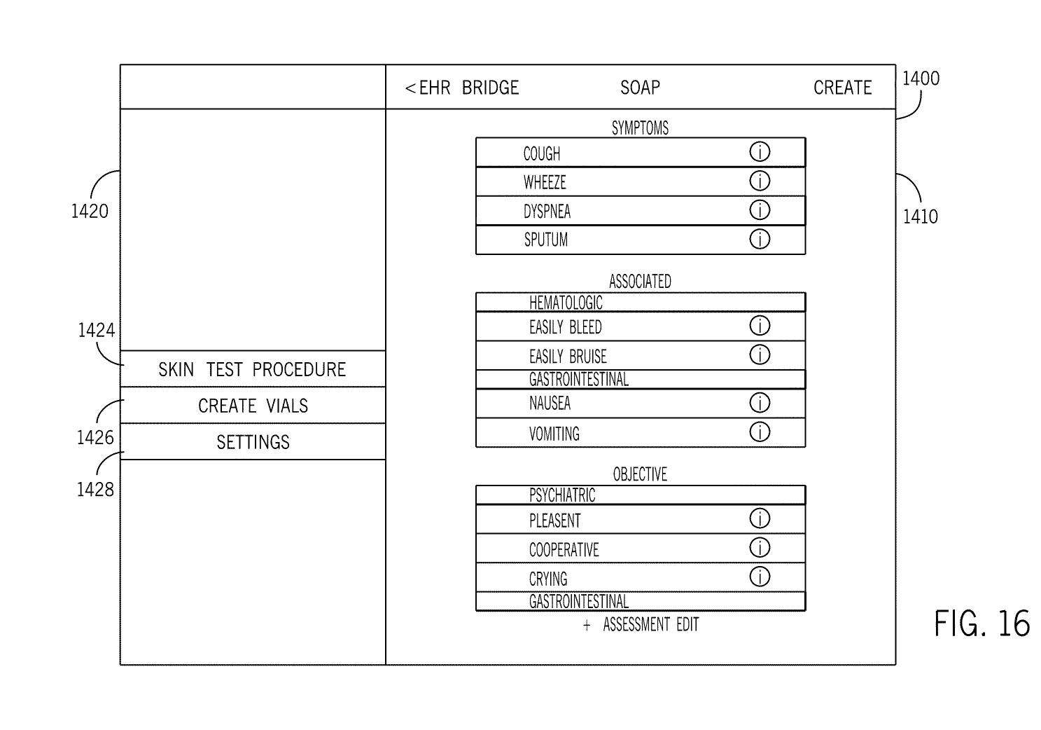

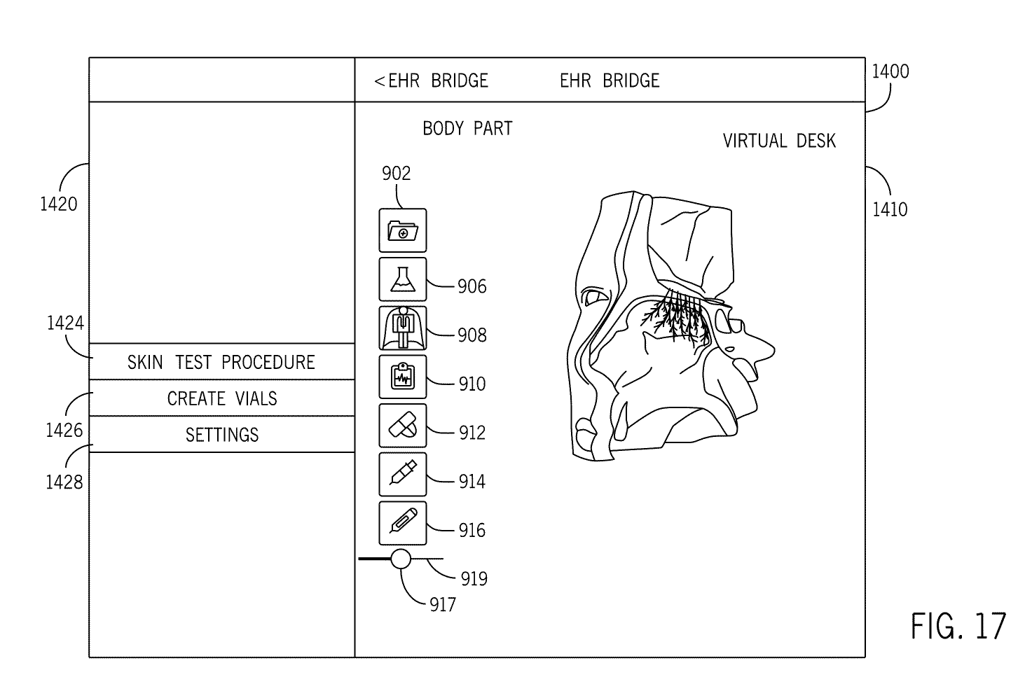

As a more specific example, FIG. 14 depicts an example GUI table showing items that may be selected by an allergist: skin test procedure selector 1424, create vial selector 1426 and a setting selector 1428. Referring to FIG. 15, in response to the create vials selector 1426 being selected, the conduit tool 110 displays different allergens in the panel 1420 and displays in the panel 1410 different vials that may be created by selecting the allergens. FIG. 16 depicts another example in which the panel 1410 displays symptoms, objective assessment categories, as well as other possible SOAP documentation options, in response to a particular body part in FIG. 14 being selected. FIG. 17 depicts another example, in which, in response to a selection on the model 901 (FIG. 14) near the nose, a 3-D more detail image of the nasal cavity anatomy is displayed in the panel 1410.

While a limited number of examples have been disclosed herein, those skilled in the art, having the benefit of this disclosure, will appreciate numerous modifications and variations therefrom. It is intended that the appended claims cover all such modifications and variations.

What is claimed is:

1. A method comprising:
displaying an anatomical model of a human on a display of a processor-based machine; and
in the processor-based machine, processing input data acquired from a user interacting with the displayed anatomical model to provide or update an electronic health record in response to an encounter between the clinician and a patient, the processing comprising:
selecting an interface from a plurality of interfaces based on user interaction with the displayed anatomical model as a result of the encounter;
displaying the selected interface; and
gathering input data in response to the user interaction with the selected interface; and
determining content to be included in the electronic health record based at least in part on the input data.

2. The method of claim 1, wherein:
displaying the anatomical model comprises displaying a skin map; and
selecting the interface comprises:
detecting selection of an area of the skin map from a plurality of areas of the skin map; and
selecting the interface based at least in part on the detected selection of the area of the skin map.

3. The method of claim 2, wherein:
selecting the interface comprises:
selecting a symptom list from a plurality of symptom lists based at least in part on the detected selection of the area of the skin map; and
displaying the selected interface comprises:
displaying the selected symptom list.

4. The method of claim 3, further comprising:
detecting selection of a symptom from a plurality of symptoms of the selected symptom list;
selecting a condition list from a plurality of condition lists based at least in part on the selected symptom list.

5. The method of claim 1, further comprising:
displaying a marker on the displayed anatomical model based at least in part on the human interaction with the anatomical model, the marker being associated with documentation about a chief complaint associated with a location on the model identified with the marker;
wherein gathering the input data comprises:
filtering candidate information to be included in the documentation based at least in part on a location of the marker on the anatomical model.

6. The method of claim 5, wherein the documentation comprises a subjective, objective, assessment and plan (SOAP) note.

7. The method of claim 5, wherein the filtering comprises filtering out candidate information associated with symptoms or conditions not associated with a body part identified by the human interaction with the anatomical model.

8. The method of claim 1, wherein displaying the anatomical model comprises:
displaying a first image of at least part of a human body on the display;
in response to the user interaction with the first image, displaying a second image of a more detailed subpart of said at least part of the human body; and
selecting the interface based in least in part on user interaction with the second image.

9. The method of claim 1, wherein:
displaying the anatomical model comprises displaying a human body image on a first portion of the display;
displaying an image of table view content in a second portion of the display separate from the first portion; and
manipulating at least one of the table view content and the human body image in response to selections made by the user to the table view content.

10. An apparatus comprising:
a display to form an image of an anatomical model of a human;
an input device to indicate interaction of a user with the image; and
a processor to respond the interaction indicated by the input device to provide or update an electronic health record for a patient in response to an encounter between a clinician and the patient, the processor to:
select an interface from a plurality of interfaces based on user interaction with the displayed anatomical model as a result of the encounter;
display the selected interface; and
gather input data in response to the user interaction with the selected interface; and
determine content to be included in the electronic health record based at least in part on the input data.

11. The apparatus of claim 10, wherein the processor is adapted to:
provide a time line graphical user interface;
provide markers, each marker being associated with clinician documentation pertaining to a chief complaint and being associated with an area of the body associated with the chief complaint; and
selectively display the markers based on user interaction with the time line graphical user interface.

12. The apparatus of claim 10, wherein the processor is adapted to:
display a skin map;
detect selection of an area of the skin map from a plurality of areas of the skin map; and
select the interface based at least in part on the detected selection of the area of the skin map.

13. The apparatus of claim 12, wherein the processor is adapted to:
select a symptom list from a plurality of symptom lists based at least in part on the detected selection of the area of the skin map;
display the selected symptom list;
detect selection of a symptom of the selected symptom list from a plurality of symptoms of the selected symptom list;
select a condition list from a plurality of condition lists based at least in part on the detected selection of the symptom;
display the selected condition list;
detect selection of a condition of the selected condition list from a plurality of conditions of the selected condition list; and
generate data documenting a chief complaint for the patient based at least in part on the selected condition.

14. The apparatus of claim 10, further comprising a handheld processing unit comprising the display, input device and processor.

15. An article comprising a non-transitory computer readable storage medium storing instructions that when executed by a computer cause the computer to:
form an image of an anatomical model of a human on a display of the computer;
an input device to indicate interaction of a user with the image; and
a processor to respond the interaction indicated by the input device to gather data documenting an encounter between a clinician and a patient to provide or update an electronic health record for the patient, the processor to:
select an interface from a plurality of interfaces based on user interaction with the displayed anatomical model as a result of the encounter;
display the selected interface; and
gather input data in response to the user interaction with the selected interface; and
determine content to be included in the electronic health record based at least in part on the input data.

16. The article of claim 15, the storage medium storing instructions that when executed by the computer cause the computer to:
provide a user interface to allow selection of a plurality of documents associated with the patient; and
provide a virtual desk to allow viewing and image manipulation of the selected documents.

17. The article of claim 15, the storage medium storing instructions that when executed by the computer cause the computer to:
provide a user interface to allow overlaying of at least two of the documents to allow a time lapse view of medical history.

18. The article of claim 17, wherein the at least two documents comprise image scans of the patient.

19. The article of claim 15, the storage medium storing instructions that when executed by the computer cause the computer to:
displaying a marker on the displayed anatomical model based at least in part on the user interaction with the anatomical model, the marker being associated with documentation about a chief complaint associated with a location on the model identified with the marker; and
filter candidate information to be included in the documentation based at least in part on a location of the marker on the anatomical model.

20. The article of claim 19, wherein the documentation comprises a subjective, objective, assessment and plan (SOAP) note.
